(19) United States
(12) Patent Application Publication
(10) Pub. No.: US 2018/0112837 A1
(43) Pub. Date: Apr. 26, 2018

(54) SOLID STATE FLUORESCENT LAMP AND HIGH INTENSITY DISCHARGE REPLACEMENT

(71) Applicant: INNOSYS, INC., Salt Lake City, UT (US)

(72) Inventor: Laurence P. Sadwick, Salt Lake City, UT (US)

(21) Appl. No.: 15/557,430

(22) PCT Filed: Mar. 10, 2016
(86) PCT No.: PCT/US16/21890

§ 371 Date: Sep. 11, 2017

(51) Int. Cl. F21K 9/278; H05B 37/02; F21S 9/03; H05B 33/08

(52) U.S. Cl. CPC F21K 9/278; H05B 37/0227; F21S 9/03; F24F 11/46; H05B 37/0218; H05B 37/0272; H05B 33/0854

(57) ABSTRACT

A lighting system comprising a solid state replacement lamp configured to replace a non-solid state lamp in a lamp fixture, a power supply configured to convert power drawn from the lamp fixture to power at least one solid state light, and a power output for an external electronic device connected to the solid state replacement lamp.

### BACKGROUND

Fluorescent and high intensity discharge (HID) lamps are widely used in a variety of applications, such as for general purpose lighting in commercial, industrial, office, home and residential locations, etc. Conventional fluorescent tubes and HIDs used for general lighting cannot, in general, be directly plugged into alternating current (AC) voltage lines. Fluorescent lamps generally include a glass tube, circle, spiral or other shaped bulb containing a gas at low pressure, such as argon, xenon, neon, or krypton, along with low pressure mercury vapor. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies.

Electronic ballasts convert the input AC voltage supplied (typically at a low AC frequency of 50 or 60 Hz) power into generally a sinusoidal AC output waveform typically designed for a constant current output in the frequency range of above 20 to 40 kHz to typically less than 100 kHz and sometimes greater than 100 kHz.

Fluorescent and HID lamps can suffer from a number of disadvantages, such as a relatively short life span, flickering, and noisy ballasts, etc. However there are many high quality electronic ballasts that are available. Although the ballasts may be of high quality and long life, often the fluorescent tubes that are powered by the ballasts, suffer from a number of undesirable effects including reduced lifetime due, for example, to being switched on and off too often. Therefore it would be desirable to have a replacement for fluorescent tubes that are not susceptible and immune from such effects or at least not so susceptible to these undesirable issues and effects. Furthermore, as replacements for fluorescent tubes are installed, the electrical contacts or pins at the ends of the tube replacements are exposed, which can carry dangerously high electrical currents. In addition, the fluorescent tubes are not able to allow intelligence, connectivity, communications, or support additional electronics, sensors, detectors, controls, etc. Therefore it would be highly desirable and useful to have the ability and capability to replace fluorescent tubes with solid state lighting (SSL) including but not limited to light emitting diodes (LEDs), organic light emitting diodes (OLEDs), quantum dot-based (QD)-based LEDs, etc. that are smart, intelligent, connected and permit the ballasts to create a digital lighting platform as well as a sensor, detector, communications, etc. power hub, source and support for digital communications of all types and forms including but not limited to big data, environmental, information, entertainment, infotainment, etc.

### SUMMARY

The present invention provides a fluorescent and/or HID replacement that, for example, powers an LED and/or OLED and/or QD lamp from a fluorescent fixture, including operating and being powered by electronic ballasts. Embodiments of the present invention also allow for digital lighting and a digital platform in general.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 depicts a circuit schematic of an example embodiment of a fluorescent lamp LED or HID replacement where, among other things, a capacitor or capacitors are used to set the solid state light output that can be remote controlled and monitored.

FIG. 2 depicts a PWM or one-shot controller that can be used to close a switch across the power input of FIG. 1 to regulate the output current and/or power.

FIG. 3 depicts an example of a feedback control circuit to provide a constant output current or for other purposes using a setpoint reference signal.

FIG. 4 depicts a circuit schematic of an example embodiment of a fluorescent lamp LED or HID replacement where, among other things, shunting is used to set the solid state light output that can be remote controlled and monitored.

FIG. 5 depicts a one-shot or PWM-based shunt control circuit that can be used with the fluorescent lamp LED or HID replacement of FIG. 4 to provide a voltage turn-on characteristic that is compatible with certain types of ballasts such that a Zener diode or diodes (e.g., 510) limits and sets the turn on point.

FIG. 6 depicts an over-voltage protection and/or over-temperature protection circuit that can be used with the fluorescent lamp LED or HID replacement of FIG. 4.

FIG. 7 depicts another schematic version of the present invention including inputs for, for example, two pairs of bi-pin connections to a ballast and tombstone in a fluorescent lamp fixture, which can include a buck switching circuit that can be used with both a ballast or AC line which can also be optionally remote controlled and have features including but not limited to over temperature protection (OTP), over voltage protection (OVP), short circuit protection (SCP), over current protection (OCP), undervoltage protection (UVP), dither, etc. and can be used with all types of ballasts including electronic rapid start, instant start, programmed start, preheat, magnetic, etc. that can be remote controlled and monitored and also has remote control/dimming.

FIG. 8 depicts a one-shot or PWM-based shunt control circuit and over-voltage protection and/or over-temperature protection circuit that can be used with the fluorescent lamp LED or HID replacement of FIG. 7.

FIGS. 9-10 depict an example of a self-contained solid-state fluorescent tube replacement with motion and optionally other sensors incorporated into certain implementations of the present invention.

FIGS. 11-12 depict an example of a self-contained solid-state fluorescent tube replacements with motion and optionally other sensors incorporated into certain implementations of the present invention including external motion and sound sensors.

FIGS. 13-15 depict block diagrams of example embodiments of the present invention that can be used for both AC lines and ballast mode that can be remote controlled and dimmed in both modes.

FIG. 16 depicts a block diagram of a fluorescent lamp LED or HID replacement with bi-directional communications with multiple sensors.

FIG. 17 depicts a block diagram of a fluorescent lamp LED or HID replacement with bi-directional communications with a variety of example sensors, inputs and controllers.

FIG. 18 depicts a block diagram of a fluorescent lamp LED or HID replacement with bi-directional communications with a variety of example sensors, inputs, controllers and power sources.

FIG. 19 depicts a block diagram of a fluorescent lamp LED or HID replacement with bi-directional communications with a variety of example sensors, inputs, controllers and power sources.

FIGS. 20-31 depicts block diagrams of various example embodiments of the present invention that can be used for both AC lines and ballast mode in AC and/or DC power modes that can be remote controlled and dimmed in both modes.

FIGS. 33-34 depict block diagrams of fluorescent lamp LED or HID replacements with bi-directional communications with a variety of example sensors, inputs, controllers and power sources as well as with customer detection/response and/or advertisement.

FIG. 35 depicts an example embodiment of a fluorescent lamp LED or HID replacement with PWM or one-shot shunt control and forward power conversion.

FIG. 36 depicts an example embodiment of a fluorescent lamp LED or HID replacement with PWM or one-shot control and protection circuits and isolated power outputs.

### DETAILED DESCRIPTION OF THE INVENTION

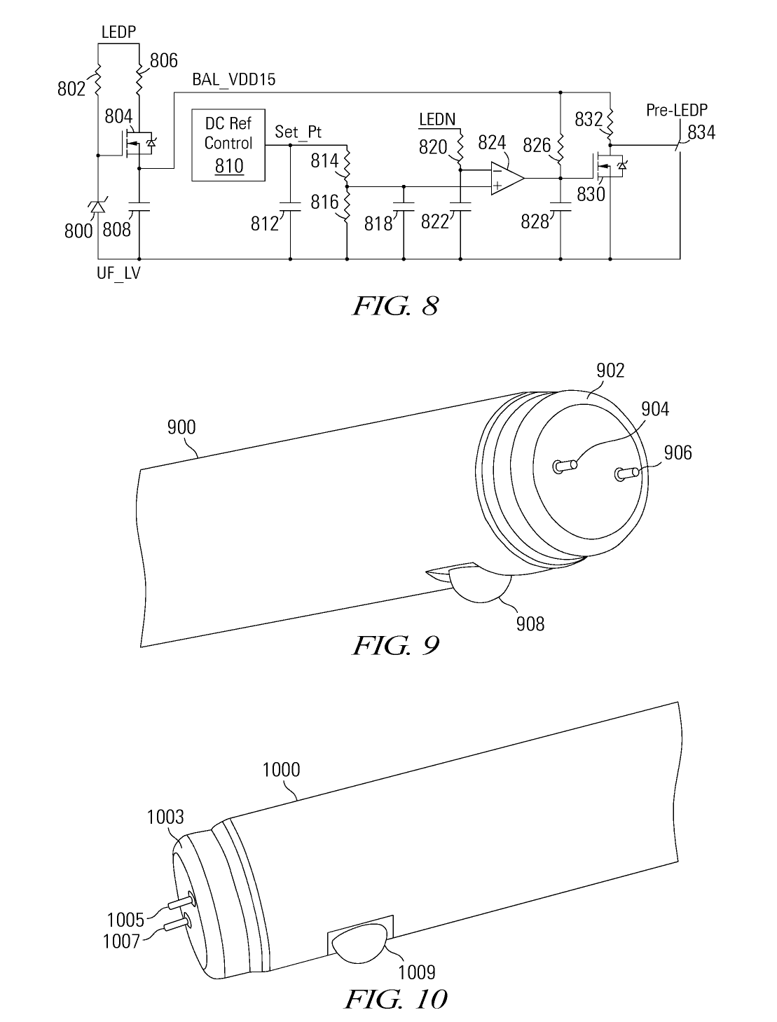

The present invention can have incorporated or integrated motion, PIR, infrared, ultrasonics, sonar, radar, voice, speech, carbon monoxide, carbon dioxide, air quality, pressure, humidity, sound, noise, vibration, gas, ambient light, light, color, photo, temperature, spectrum, etc. combinations of these sensor(s), etc. of the same or different types, etc. as part of the housing and can also use auxiliary motion sensors and can also have integrated light/photocell sensor as well as being auxiliary, external and powered by the ballast and providing connectivity and communications to other lamps, sensors, detectors, systems including but not limited to HVAC, security, entertainment, environmental, Internet of Things (IOT), etc. In some embodiments of the present invention, these can be stand-alone units that replace conventional fluorescent and HID lamps including, but not limited to, T5, T8, T12, T5, T10, T9, U-shaped, CFLs, etc. of any length, size and power as well as high intensity discharge lamps of any size, type, power, etc. Such embodiments and implementations of the present invention can be used, for example, in stairwells, staircases, closets, classrooms, offices, auditoriums, closets, storage and related facilities, gyms, warehouses, etc.—essentially any lighting application where the lights are used relatively infrequently. In addition to saving energy, the life of the solid state lighting will be extended by dimming or turning off and can be programmed including over the air (OTA) programmed and also act, behave, operate and function autonomously or, be part of a group or even lead a group depending for example of the implementation of the present invention. For example, the lighting may be on for only a few minutes each day or once every few days in, for example, but not limited to, a closet situation, etc. Embodiments of the present invention can be designed to have multiple sensors of the same or different types, combinations of sensors, etc., as shown in FIGS. 9-12. Although a solid-state lighting replacement for fluorescent lamps is shown in FIGS. 9-12, the present invention is equally applicable to HIDs of all types, etc. The present invention can also be designed to work with and be connected (e.g., wired or wirelessly) to new construction lighting and lamps such as but not limited to 2×2 and 2×4 ft ceiling tile lights designed for gridded ceilings, hung from ceilings, etc. and other types of solid state lighting including ones designed to be mounted, built-in, attached, etc. to ceilings including new construction ceilings, SSL or other wall, floor, etc. lighting including but not limited to linear lighting, cove lighting, sconce lighting, pendant lighting, under cabinet light, ceiling lighting, bathroom lighting, gymnasium, sports, events, theatre, etc. lighting and together function as an integrated, networked, connected digital ceiling and digital platform with seamless connectivity between new and old, retrofit, replacement and new construction independent of the fixture type and power source type (e.g., ballast vs. 50/60 Hz AC mains/lines, power over Ethernet (POE), off-grid, etc.), etc. With the present invention, the sensors, IOT, controls, etc. can be incorporated into the SSL replacement lamps and lights or can be attached via wires/cables, etc. that provide power and also, in some embodiments, provide wired communications with the sensors, detectors, IOT, controls, etc. which allow the sensors to be attached, hung, clipped, taped using for example but not limited to double sided tape, 3M Command contact, pins, supports, screws, rivets, etc. The sensor housings and parts of the SSL replacement lamps such as but not limited to the end caps of the linear fluorescent lamps, the sockets of the SSL replacement lamps for the HIDs, etc., can be made using any processes including extrusion, laser cutting and machining. 3D printing and other additive manufacturing processes, etc.

The present invention can also respond to proximity sensors including passive or active or both, as well as voice commands and can be used to turn on, turn off, dim, flash or change colors including doing so in response to an emergency situation. The present invention can use, for example, but not limited to, wireless, wired, powerline (PLE), power over Ethernet (POE), combinations of these, etc., Bluetooth, Bluetooth low energy (BLE, BTLE, etc.), Bluetooth classic, RFID, WiFi, ZigBee, ZWave, IEEE 801, IEEE 802, ISM, etc. In addition the present invention can be connected to fire alarms, fire alarm monitoring equipment, etc.

The present invention can use building automation systems (BAS) such as a BACNET to wireless converter box or BACNET to Bluetooth including Bluetooth low energy (BLE, BTLE, etc.) converter. The present invention can also use infrared signals to control and dim the lighting and other systems. The present invention can also serve and have/provide gateways to, for example, POE, cellular networks including, but not limited to, cellular modems, etc., severs, etc.

The present invention can share intelligence such that more than one florescent lamp replacement (FLR) can use, respond, be controlled, be monitored, etc. by the same wireless and/or wired, etc. interface. Such shared abilities can also be field installable and/or field upgradable as well as can non-shared abilities using a connector interface that provides for power, dimming, and/or other interactions, combinations of these, etc. with various embodiments and implementations of the present invention. The firmware can be updated/uploaded/etc. over the air.

The capability for upgradeable firmware is critical to “future-proofing” to prevent lamp obsolescence As improved software applications and sensors are developed, with the present invention, one can wirelessly (or wire) upgrade the firmware to work with these improving, enhanced, lower cost, etc. technologies and other Internet-of-Things technologies, including wearables.

The present invention can use a BACNET to wireless converter box or BACNET to Bluetooth including Bluetooth low energy (BLE, BTLE, etc.) converter. The present invention can also use infrared signals to control and dim the lighting and other systems. The present invention can also serve and have/provide gateways to, for example, POE, cellular networks including, but not limited to, cellular modems, etc., severs, etc.

The present invention can have the motion proximity sensor send signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc. The present invention can be programmed to switch manually, automatically, sequenced, scene-based, etc., from using motion, proximity, sound, vibration, occupancy, vacancy, face recognition, vision recognition, voice recognition, pattern recognition, gesturing, etc., combinations of these and others discussed herein, etc. to go from using these to detect/sense/decide/etc. whether to turn the lights (and other functions including environmental functions such as temperature, humidity, (HVAC), etc.) to becoming a security system or part of a security system and alerting/alarming/responding including but not limited to locally or remotely, when one or more of the above is sensed or detected when, for example, but not limited to, none should be.

Embodiments and implementations of the present invention allow for portability and essentially instant connectivity control, monitoring, meshing, networking, etc. including, for example, but not limited to, being installed in one location and after some period of time (e.g., but not limited to, from less than days to more than 10 years), for whatever reason—new construction, demolition, damage due to natural causes (wind, earthquake, hurricanes, tornados, avalanche, etc), other man-made and natural reasons, etc., it can be transferred and moved to another location whether it be nearby (e.g., 100 feet away, 1 mile away, 10 miles away, or far away, across the country, across the world) and re-installed in its new location and quickly commissioned and up and operational again.

Embodiments and implementations of the present invention allow for optional add-ons including but not limited to wired, wireless, POE, and/or powerline control to be added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

Examples of adding smart control and monitoring include having wires or connectors that allow the connection of external sensors and detectors, external controls and monitoring, etc. that can be powered by the ballast directly or indirectly.

In addition, battery charging can also be employed and incorporated into embodiments and implementations of the present invention such that the charging unit can allow the ballast to supply no power to all or parts of the system and also can function when the ballast is switched/turned off. In some embodiments of the present invention, the system can monitor the battery energy/level/strength/condition/etc. such that the system can turn on or electrically reconnect to the ballast to charge the battery or batteries from the ballast.

In some embodiments of the present invention, complete blocking and turn-off of the ballast to conserve energy can be used.

In some embodiments of the present invention, complete shorting/shunting of the ballast current to conserve energy can be used.

The present invention can have additional lighting and features such that it can provide various types of alerts including flashing lights, flashing color lights, etc. Embodiments and implementations of the present invention can have various modes that can work together to detect and respond to detection of the presence of people and optionally animals including but not limited to motion, PIR, IR, ultrasonic, sonar, radar, microwave, RF, capacitive, inductive, touch, voice, noise, energy, mechanical, vibration, displacement, vocal commands, other commands, clapping, barking, etc.

The present invention can use speakers or earphones or combinations of both to communicate with people and users, etc.

The present invention can share intelligence such that more than one FLR can use, respond, be controlled, be monitored, etc. by the same wireless and/or wired, etc. interface. Such shared abilities can also be field installable and/or field upgradable as well as can non-shared abilities using a connector interface that provides for power, dimming, and/or other interactions, combinations of these, etc. with various embodiments and implementations of the present invention. The firmware can be updated/uploaded/etc. over the air.

The present invention includes a plug-and-play LED linear and other fluorescent-replacement lamps and a LED HID-replacement lamps with current-control technology that provides constant current which further provides for constant lumens and allows for constant and consistent lumen depreciation and overcomes the problem of equal brightness between different ballast types, models, manufacturers, etc. Embodiments and implementations of the present invention are also dimmable including by using smart phones, tablets, computers, servers, etc. This provides a low-cost (eliminates labor costs associated with retrofitting fixtures), efficient (much less energy/power for the same lumens compared to fluorescent and HID lamps) replacement for fluorescent and HID lamps that work with a diverse and vast number, type and array of sensors, detectors, controls, etc.

Embodiments of the present invention provides for multi-directional communication networks, meshes and connectivity. The communications built into the lamp drivers allows user-to-lamp, lamp-to-user, lamp-to-lamp, and sensor-to-lamp communications which can also enable signal perpetuation throughout a building

The present invention also enables the lamps to both power and communicate with sensors and “follower lamps.” “Follower” lamps are lamps that mimic exactly what the “leader” lamp does—turn on, turn off, dim, flash, etc.; follower lamps are, for example, but not limited to, connected via safe, low-voltage wires to the Leader lamp. A wide variety of sensors can be used: occupancy of all kinds and types, daylight, carbon dioxide, carbon monoxide, humidity, air quality, temperature, etc.; one can wire the sensor directly to the lamp and secure it to the fixture or the surrounding surfaces (e.g., the ceiling). The present invention enables wirelessly and/or wired firmware upgrades/updates.

Embodiments and implementations of the present invention include multi-directional communication network capabilities. Embodiments of the present invention enable remote controllability via the fluorescent and HID lamp replacements. As a non-limiting example, a control signal could be, but not limited to, sent from a desktop computer, a laptop computer, a phone, a tablet, a server, etc. to, for example, a conference room in an opposite side of the building and the present invention lamps would perpetuate the signal from lamp to lamp until the conference room lamps receive the signal and respond appropriately. Similarly, a control signal could be, but not limited to, sent from a desktop computer, a laptop computer, a phone, a tablet, a server, etc. in an office or elsewhere to, for example, a warehouse area or gymnasium in an opposite side of the building and the present invention lamps would perpetuate the signal from lamp to lamp until the warehouse area or gymnasium lamps receive the signal and respond appropriately. With the present invention the lamps could also send “distress” signals, indicating the need for attention/replacement. Another application would be lamps coordinating data from sensors to, for example, illuminate a path for occupants (hallways, emergency situations where lamps signal direction to exits or location of distress, etc.) and the same lamps could also be used and tasked with using the same and/or additional, other sensors such that the lamps and also, depending on the implementation, the sensors, communicate the location and direction-of-travel of an intruder and provide, for example, but not limited to, user-specified/selected/etc. alerts, alarms, etc. and/or automatically generated alerts, alarms, etc.

Embodiments of the present invention can provide, for example but not limited to, external powering and control and sensing for current and future sensors, controls, automation, communication, connectivity, networking, security, comfort, environment and ambient control, monitoring, logging, analytics, etc., health monitoring, health care, productivity, performance, sleep, rest, etc. The present invention lowers the cost of the lamps (as a non-limiting example, only one per fixture needs to be smart, independently intelligent, etc.) easing adoption and also simplifying the process of sensor implementation—one does not need to run wires through ceilings and walls to install a new sensor—instead simply power it with the present invention lamps and perpetuate the signal using, for example, but not limited to a mesh network.

The capability for upgradeable firmware is critical to “future-proofing” to prevent lamp obsolescence As improved software applications and sensors are developed, with the present invention, one can wirelessly upgrade the firmware to work with these improving, enhanced, lower cost, etc. technologies and other Internet-of-Things technologies, including wearables. The wearables can interact with and communicate with the lighting, smart and intelligent drivers and power supplies that derive and get their power from the ballasts to, for example customize the lighting, temperature, humidity, and general ambient environment of the user/wearer of the wearables as well as monitor, log, analyze, respond to the information being provided by the wearables including health, comfort, vital signs, condition, etc. of the user/wearer of the wearable and respond accordingly. In addition to designing for advanced energy efficiency, lighting technology needs to prepare and be capable of/for a future movement to the Internet-of-Things (IOT), the present invention provides an instant, transportable, moveable, portable digital ceiling that can be as permanent or temporary as desired or needed. Upgradeable firmware will also allow for integration of future software, which for example, but not limited to, allows the present invention lighting to also serve multiple, non-lighting purposes such as, but not limited to, HVAC/air-quality control, automatically switching to a security system when the building is vacant, color tuning for maximum human performance and health benefits, etc. The upgradeable firmware and flexibility in the smart and intelligent drivers and power supplies as well as the modules that can be attached including field attached and field-upgradeable will allow the present invention to continue to be able to incorporate the latest and newest advances and offerings, protocols, features, functions, networking, IOT solutions, etc. from, for example, companies such as Alphabet, Apple. Cisco, Google, Intel, Qualcomm, etc.

The present invention offers intelligent, plug-and-play LED fluorescent and HID lamp replacements and does not need, require a renovate/retrofit model that requires, for example, a complete fixture replacement (expensive in both hardware and labor) and potentially ceiling replacement, remediation, removal of hazardous materials, generation of dust, etc. The present invention provides for a low-cost-for-intelligence approach, where existing fixtures can be used to power intelligent lamps and sensors, which are portable and transferable and can be reconfigured to a new space. The present invention offers intelligence for much lower cost which can provide the same intelligence benefits as high-cost approaches while also offering features such portability/transferability.

The present invention offers intelligent fluorescent and HID SSL/LED lighting as the foundation of a smart building and allows buildings to become quickly and seamlessly connected and intelligent including lighting, HVAC, monitoring, analytics, security, etc.

The time and cost required to bring intelligent lighting (which saves up to 85% energy) into buildings keeps many building owners and tenants from taking this step. With linear fluorescent lighting, which comprises 80% of commercial and industrial lighting, the difficulty of making LED lighting work with the ballast usually results in removing or retrofitting (ballast removal) fixtures or in simply using basic plug-and-play lamps that offer no control including no control of the light output (no constant lumens) with the light output often highly dependent on the ballast type, model, etc. In addition the use of basic, unintelligent hardware inhibits the use of advanced lighting software and can also result in inefficient and redundant or no sensor monitoring systems (such as lighting, HVAC, and security).

Embodiments of the present invention provide solutions to taking the 80% of lighting fixtures in commercial and industrial buildings and creating and implementing the basis for smart buildings. Instead of having no, limited or redundant monitoring systems and requiring expensive retrofits and renovations, the present invention uses, for example but not limited to, plug-and-play LED lamp that replaces linear and other fluorescent lamps and HID lamps of essentially all types without any need for retrofit (it works with the existing ballasts) which gives an immediate and significant energy savings. In addition to these advantages and features, built into embodiments of the present invention is two-way communication that allows the lamps to “talk” with the users (energy usage, lamp ‘health’, sensor data, etc.) and users to control the lamps (dim, change colors, turn on or off, respond to daylight or occupancy sensors in a specified way, etc.). The present invention can use an inexpensive wired/wireless sensor network, many of which simply plug into the lamps that can, for example, but not limited to network with HVAC systems (including environmental controls and sensors) to intelligently heat and cool areas only when needed, all communicated through the lighting system as well as providing security such as, but not limited to, an alarm system that uses the same sensor network for a much more extensive security system, including but not limited to having the lights report areas of suspicion to administrators and other users. The present invention allows future innovations to be incorporated via upgradeable firmware in each lamp to allow wireless upgradeability for future advanced software applications and sensors.

The present invention can provide for digital ceilings and digital walls such that the lighting can be digitally controlled, dimmed, connected, networked, meshed and also provide additional lighting environment and other non-lighting environment sensor-based controls and monitoring as well including for example HVAC, security, comfort, entertainment, emergency detection such as fire, smoke, carbon monoxide, carbon dioxide, hydrogen, natural gas, other gases, intruder, fall-detection, glass breakage, security camera and surveillance camera and video, video streaming, internet, etc. and can be compatible with, for example, but not limited to, Cisco's Digital Ceiling POE lighting for large scale IOT and lighting and HVAC and other digital communications as well as Apple Inc.'s digital ceiling and related lighting approaches.

Embodiments and implementations of the present invention allow for instant and rapid deployment of advanced sensor-based networking, detection and response using, for example, but not limited to, the fluorescent and/or HID ballasts as power sources to power and enable vast, diverse and connected networks of lighting, HVAC, security, intelligence, learning and adaptive lighting including but not limited to occupancy and vacancy detection and response to specific locations using sensors to determine for example, proximity, presence and patterns and be predictive using, for example, intelligent, smart enabled fluorescent and HID replacement lighting that, for example, provides a source of power for sensors and other IOT as well as being able to turn the fluorescent and HID ballasts into a source of power and intelligence for the control and management systems, including but not limited to building controls and management, lighting controls and management, HVAC controls and management, data monitoring and gathering, logging and analytics including but not limited to Big Data mining of part or all of the sensor network for, for example, but not limited to, energy-conscious uses, energy waste and inefficiencies, traffic patterns and usage including human and other traffic patterns and usage including but not limited to customer, visitor employee, intruder, etc. traffic patterns, destinations, amount of time spent, etc. as well as using the ballast to provide power for providing wireless access points for WiFi, Bluetooth, LiFi, other light and lighting communications, protocols, interfaces, etc., cellular carriers including cellular modems and modules, gateways, etc. and the overall network structure and infrastructure.

The present invention can use various ways and connections and connectivity to connect the wired components including sensors, IOT, applications, computers, smart phones and tablets, controls, entertainment, etc. using for example, USB connectors, other standard and proprietary connectors, including for example DMX, DALI, push terminals, connector and cable adapters, printed circuit board connectors and edge card connectors, connectors used to connect Cat 5, Cat 6 cables, Ethernet connectors to connect Ethernet connectors, POE connectors, RJ45 connectors, etc., made by companies including but not limited to Molex, TE Connectivity, Samtec, Tyco, JST, Wago, etc. As an example implementation of such wired connecting, connectivity, connections, etc., a five pin connector consisting of ground, power (e.g. 5 volts), SPI or I2C signals including clock can be used to connect to the smart power supplies and drivers powered by the ballast for the present invention. Additional pins (e.g., a total of six, seven, eight, etc.) can be provided to provide additional power at various voltages (e.g., 1 V, 3 V, 3.3 V, 9 V, 12 V, 15 V, 20 V, 24 V, 48 V, +/−5 V, +/−12 V, etc.),

The lighting and other components of the present invention can be equipped with and include real-time clock(s) and other methods, technologies, techniques of setting, referencing, using, knowing, monitoring time and can also be synced up with the sensors, controls, IOT, etc. including wired or wirelessly to provide accurate and synchronized timing, including using, for example, radio transmissions of ultra-precise atomic clocks so as to synchronize, schedule, evaluate, determine, predict, etc. events, when to turn on/off the lights, HVAC, security/alarm systems, etc. The present invention can also incorporate information from building and door entry systems to determine if there is appropriate occupancy and, for example, either enable and turn-on lighting, environmental controls, HVAC including local and global zones as needed to effectively light the path, building, and/or specific areas and zones of the building including work space, desk space, office space, cubicle space, etc. for the appropriate users, workers, employees, guests, etc. including for, but not limited to, office buildings, hotel and motel buildings, libraries, schools, colleges, universities, government buildings, public buildings, other types of private buildings, hospitals, and essentially any type of building, home, house, condo, apartment, storage, garage, etc. building and/or structure. Conversely, the present invention can also be used as a security system to detect, alert, monitor, track, respond, alarm, protect, deter, identify, etc. if an unauthorized, suspicious, dubious, questionable situation or intruder is detected and automatically alert via, for example, text messages, e-mails, video surveillance images and streaming video, etc. to smart phones, tablets, telephones, other mobile devices, etc. first responders including but not limited to police, fire ambulance, etc. In a similar fashion, should one or more sensors detect, indicate, record, etc. fire, smoke, excessive carbon monoxide, carbon dioxide, natural gas, breakage, other gases, etc., text, e-mails, SMS, voice messaging including automatic voice messaging, video, photos, images, other types of alerts, alarms, etc. can be sent out including contacting first responders directly. Health and injury concerns that are detected, sensed. etc. by any method technique, technologies, etc. including the sensors, detectors, systems, etc. connected to the present invention as well as but not limited to wearables including wearables that directly or indirectly interact with the sensors, detectors, controls, IOT, WiFi, Bluetooth including but not limited to the Bluetooth Low Energy, Bluetooth Classic, Bluetooth Mesh(es) of the present invention or use the wired or wireless functions, features, capabilities, connectivity, etc. of the present invention can be alerted, alarmed, notified by e-mails, texts, phone calls, etc. of the medical situation or emergency. Specific medical wearables designed to monitor, for example, but not limited to heart conditions, epilepsy, brain conditions, brain waves, seizures, etc. can also interact with the present invention and, in a similar fashion, method, approach provide alerts including texts, phone calls, SMS, e-mails, application drive responses, etc., directly contact first responders, etc. In addition, the present invention can use the lights, speakers, voice synthesizers, bells, piezo buzzers, other audio and visual components, systems, units, etc. to provide audible and visual alerts, indications, etc. including turning lights on, turning selected lights on (or off), flashing lights, changing the color of the lights, etc. The present invention can also provide health care and productivity benefits including changing the color temperature, color, etc. of the lights based on circadian rhythm, time of day, weather, ambient light including sunlight, other conditions, etc. including but not limited to as described in patent application PCT/US15/37838 filed Jun. 25, 2015 for “Circadian Rhythm Alignment Lighting” which is incorporated herein by reference for all purposes.

The present invention is designed to work with applications (APPs) and APIs including smart phone, tablet, other personal digital assistants, etc., computer programs, etc. to provide control, commissioning, zoning, priorities, privileges, preferences, such as in patent application PCT/US15/32763 filed May 27, 2015 and PCT/US15/43691 filed Aug. 4, 2015 for “Lighting Systems” which are incorporated herein by reference for all purposes and can be used with any and all aspects of the present invention including but not limited to the lights, lighting, HVAC including but not limited to temperature, humidity, comfort, etc., security, etc. The APPs, with appropriate permission levels, can be used to control, monitor, log, change status, configuration, zones, etc. of the present invention including but not limited to the network, the sensors, the smart and intelligent power supplies and drivers, the controls, the IOT, etc. of the present invention.

The present invention provides a digital platform that is flexible, adaptable, reconfigurable, re-deployable, re-purposing, re-directed, etc. and, in general, is relatively low cost. The present invention can incorporate, use, utilize, etc., voice, speech, mood, expression, emotion, pattern, biometric, face, vision, comfort, habit recognition, etc. As a non-limiting example, face recognition can be used to determine which user is present and, for example, but not limited to, coupled with one or more of emotion, expression, mood, wearable, health, medical and other sensor information, adjust, adapt, change the lighting, HVAC, for the user in, for example, but not limited to, certain zones, areas, etc.

The present invention is not restricted to lighting form factors that it is replacing such as linear fluorescent tube lamps or HID lamps. Embodiments of the present invention can have virtually any form factor including form factors with the solid-state lighting being in strip or other formats including but not limited to linear form factors, novel form factors, Edison socket form factors, light strings, ropes, etc., light strips, etc., other form factors, combinations of these, etc.

In some embodiments of the present invention, in many cases and situations, not all of the existing tombstones of the lighting fixtures to which the ballast outputs are connected will be used. The unused tombstones are thus available to power sensors, IOT, etc. 5V, 12 V. 24 V outlets, spigots, etc. In some embodiments, implementations, applications, cases, situations, etc., with fluorescent lamps, the present invention is electrically connected directly to the tombstones which are connected to the ballasts, in other embodiments, implementations, applications, cases, situations, etc., the present invention will be directly connected to the ballasts using other types of connections including but not limited to wire nuts, barrier panels, lugs, NEMA, UL, etc. approved connectors, custom connectors, 3D-printed connectors, etc. In some embodiments, implementations, applications, cases, situations, etc., the present invention will be connected to the HID ballast through a socket, in other embodiments, implementations, applications, cases, situations, etc., the present invention will be connected to the HID ballast directly through, for example, but not limited to, wire nuts, barrier panels, lugs, NEMA, UL, etc. approved connectors, custom connectors, 3D-printed connectors, etc. In some embodiments of the present invention, a socket adapter can be installed in the HID socket that connects to the present invention and provides for the lighting and sensor-based, IOT, etc. digital ceiling elements. In some embodiments of the present invention the present invention is a HID to AC or DC power adapter.

The present invention uses zoning, meta-zoning, grouping, meta-grouping, quasi-zoning, etc. which can be preprogrammed, commissioned, or created on the fly via computers, laptops, personal digital assistants, smart phone, remote controls, tablets, etc. Such zoning and grouping of the lighting, sensors, IOT, controls, etc. can be for a temporary finite amount of time, can be scheduled, can be canceled, can be modified, can be adaptive, can be changed, etc. and can also be prioritized, have preference and permission levels, be overridden, be password or otherwise protected, etc. The meta and quasi zoning is in general used for more temporary assignments; however it can be as permanent as desired.

In addition, the present invention can also be used for marketing and sales including retail and commercial stores and markets including but not limited to grocery, department stores, clothes, jewelry, chinaware and dishware, furniture, food, beverages, restaurants, including but not limited to, sit-down, fast food, chain restaurants, etc. wholesale distributors, recreational stores, car/automobile dealerships, bookstores, office supply, home and do-it-yourself (DIY) stores, hardware stores, software stores, delicatessens, pastry shops, coffee shops, beverage shops and restaurants sporting goods stores, theatres, music halls, dance halls, opera houses, etc. in general, home renovation stores, home and business remodeling showrooms and other types of similar showrooms, display rooms, bathroom showrooms, other types of showrooms, stores, restaurants, etc.—virtually any retail or wholesale place and space that uses fluorescent or HID lighting can benefit from the present invention. Such types of marketing, sales, store, display and showroom browsing could include the present invention sensing and detecting, finding, tracking, monitoring, etc. individuals, customers, groups, students, etc. Sensors could sense, detect, monitor for, for example, facial expressions, body language, face recognition, position, velocity, speed, direction, as certain products were being advertised over a smart phone, tablet, public announcement (PA) system, TV monitor or display, etc. and use the lighting which could be, but not limited to, one or more colors including color of the lighting on the respective merchandise or product to, for example, but not limited to enhance the attractiveness and salability of the merchandise, products, etc. as well as direct and lead the person, persons customer(s), consumer(s), group, etc. to certain products based on responses including but not limited to sensor and IOT responses via, for example, but not limited to additional lighting and for example but not limited to indicator lamps and lighting that can, for example, flash, illuminate, change color, etc. to lead, direct, steer, point out, highlight, etc. The present invention can use sensors and IOT to advertise, broadcast and perform attention getting efforts to, for example, attract the attention of customers in stores including but not limited to using the present invention to interact with mobile and other wireless devices that the customer may have including sensing and detecting and interacting with and joining, connecting, communicating with such devices as well as with the customer directly, and to use patterns and predictions including those based on previous knowledge and experience with a particular customer as well as, for example, existing knowledge including publically available knowledge, social media knowledge, general media knowledge, store (or seller) knowledge, purchased knowledge, customer-provided knowledge, etc. to present the customer with special offerings, deals, opportunities, etc. and use the present invention including the lighting, sensors and IOT to help make the sale/purchase easier, more attractive and probable. The present invention can also be used in prisons and jails to sense, detect, find, track, monitor prisoners and inmates as well as supplying appropriate lighting (e.g., color temperature, color, intensity, etc.) to maintain health, productivity, attentiveness, performance, proper mood, and also provide security.

For the present invention, the sensors will generate data including but not limited to business intelligence including but not limited to sales, marketing, customer interest and preference, purchases, inventories, movements, ship, goods sold, good received, etc. from sensor data. The present invention also supports all business models for leasing and renting light including but not limited to being able to monitor the power usage, time of usage, duration of usage, cost of usage, location of usage etc. including but not limited to the lighting, the HVAC, other systems including but not limited to management systems, location of personnel, employees, customers, etc.

As an example, linear LED lighting including total replacement of fluorescent lamp fixtures currently requires at the very least a retrofit of the fixture to, at a minimum, remove the ballast because the current plug & play product options cannot provide constant lumen output or smart features such as dimming. This adds significant cost to implementing any LED lighting solution.

Much of the current lighting infrastructure delivers only light and much of the linear LED lighting is also not controllable and not networked or connected. Often LED lamps are designed to be direct replacements for existing florescent, incandescent and halogen lamps, while LED luminaires represent a change of the existing lamp and fixture system and, often, in the case of expensive retrofits, the can only be turned on or off including using a manual switch or motion or daylight harvesting. In many situations, the SSL/LED replacement/retrofit options become highly complicated or very limited by the ballast in linear fluorescent lighting, which can affect light output, lamp life, and control. Simple, non-connected, non-controlled lighting systems cannot deliver the type of digital platform discussed herein.

The wire and wireless backbone over which the Internet and internal and external information networks travel will become vital nodes of information collection and dissemination, especially when housed along and coupled with sensors that detect building occupancy, climate, and many other things including but not limited to intelligence, capability, and flexibility of lighting as a new kinds of digital platform take hold will change lighting.

The present invention allows sensors, software and systems that are integrated into lighting to create what is being referred to a ‘digital ceiling’. The present invention allows for the immediate incorporation of new features and intelligence into building and the associated business(es) through their lighting systems without the need to change, disrupt, destroy, demolish, alter, remodel, expend resources and cost on existing infrastructure.

The present invention can utilize software application platforms designed to substantially improve the installation, configuration, control, and analytics aspects of intelligent lighting.

Often the traditional way in which intelligent lighting systems have been installed and configured is labor intensive and time-consuming. Installation usually requires removal of old fixtures and/or installation of new ones. Configuration of the lighting system often involves complex systems and software that is far from user-friendly. The difficulty results in extensive contracting and maintenance costs, reduces the likelihood of frequent system adjustments to improve efficiency and user satisfaction, and prevents a wider adoption of intelligent solid-state lighting (SSL) technologies altogether.

Reliable, robust intelligent lighting systems will positively affect the commercial and industrial ecosystem by providing the foundation for a smart building. This provides building owners and tenants with the best first step for both energy savings and for installing a sensor network that can be used for other benefits, such as greater HVAC and equipment efficiency and alarm-system security and numerous other IOT applications including camera monitoring, voice communications and recognition, etc. Additionally, the hardware and software could also be applicable to other SSL products including but not limited to LED and OLED products including for example, but not limited to area lamps, task lamps, desk lamps, under cabinet lighting, cove lighting, overhead lighting, accent lighting, other types of lighting discussed herein, etc. in a variety of settings.

The present invention provides an intelligent SSL/LED lighting platform which includes direct plug and play HID and fluorescent lamp replacements that works with any ballast, dramatically reducing installation costs by eliminating the need to retrofit lighting. The present invention includes smart and intelligent drivers that have ability to control linear LED lights (e.g. dimming) even when used with a ballast which allows a vast and diverse types of sensors to be employed and used including for daylight harvesting that provide continuously dimmable light in response to the daylight harvesting rather than the typical on/off or bi-level or, at most, tri-level capability. The present invention has the built-in ability to incorporate all types of other sensors including but not limited to proximity, vacancy, occupancy, etc. further enhancing savings while also allowing information to be stored and/or transmitted from the light such as energy use or sensor data with the intelligent and smart drivers that can upgraded to incorporate new sensors and controls as they become available. The present invention offers digital ceilings that require no retrofit costs and can, in general, be installed, in general, by non-professionals, thereby the substantially reducing the costs of installation of a smart/intelligent LED Lighting system costs compared to other approaches. The sensor and IOT integration is important to creating a “digital ceiling” in which all kinds of services can be delivered via iLumens smart lighting systems as well as upgradeable firmware which allows the lights, sensors, IOT, etc. to effectively be ‘future proof’ as they can be upgraded to support new technologies as they are introduced.

The present invention allows for self-commissioning, will plug into common receptacles, will have upgradeable firmware, and will be controlled via software suites to optimize lighting personalization and experience. Also, embodiments and implementations of the present invention can have one or more separate LED arrays that, for example, can point in different directions and/or be of different colors or color temperatures and be optionally configured in a sleeping LED array configuration to allow different light intensities and, in some cases, different color or color temperatures and/or intensities to illuminate different areas of the work space (i.e., cubicle, interior walls, ceilings, other work spaces, non-work spaces, etc.).

The intelligent and smart controls include installed hardware such as wall or portable dimmers and on/off/sequence/etc. switches or mobile devices (e.g., smart phones, tablets, laptops, desktops and servers also simplify the installation, configuration, control, and analytics aspects of an intelligent lighting system such that it can be self-commissioning.

The intelligent HID and fluorescent LED platform can be applied to customers in the commercial, office, and industrial sectors. Commercial beneficiaries include but are not limited to Education, Food Services/Stores, Health Care, Lodging. Offices, Public Assembly, Public Order/Safety, Religious Worship, Retail, Services, Warehousing/Storage, and Other Locations. Industrial beneficiaries include, but are not limited to, Apparel, Beverage/Tobacco, Chemicals. Computers, Electronics, Retail, Grocery, Electrical Equipment Appliances/Components, Fabricated Metal Products, Food, Furniture & Related Products, Leather & Allied Products, Machinery, Non-Metallic Minerals, Paper, Petroleum/Coal, Plastics/Rubber, Primary Metals, Printing & Related Support, Textile Mills. Textile Product Mills, Transportation, Wood. and Miscellaneous Others.

Consumers in commercial and industrial spaces most likely will need to improve their level of control and quality of lighting. Even basic lighting functions, such as dimming, are largely unavailable to workers in these spaces. The integration of smart and intelligent driver technology into new and common form factors, in conjunction with advanced simplification software, will make not only dimming, but also a variety of other personalization options available, such as color tuning, scheduling, occupancy, security, added safety, and remembered and recognized personalized lighting profiles.

The present invention provides smart and intelligent Plug & Play, future-proof, dimmable, constant lumens, two-way communications, typically 50-90% energy savings over traditional legacy lighting for which embodiments and implementations that work with essentially any electronic and magnetic ballasts as well as working with AC line voltage. The present invention requires no rewiring, has significantly reduced costs for installation and maintenance, fits numerous and diverse fixtures including for example explosion-proof fixtures, with predictable, dependable light output.

The present invention allows complete and comprehensive meshing, networking, connecting, connectivity with new construction lighting with the replacement lighting. Embodiments of the present invention can use ballast now and use AC line later. The present invention, among other things, features, functions, etc. also provides portable Internet-of-Things capability, comprehensive sensor integration, energy management and can be cybersecure capable, is fully and continuously dimmable including with, but not limited to, daylight harvesting which can automatically and autonomously, for example, continuously dim on a sunny day and can also be dimmed manually, dims via software application, etc. The present invention provides an energy-saving, intelligent plug-&-play SSL/LED lighting solution that fully supports digital lighting and digital platforms.

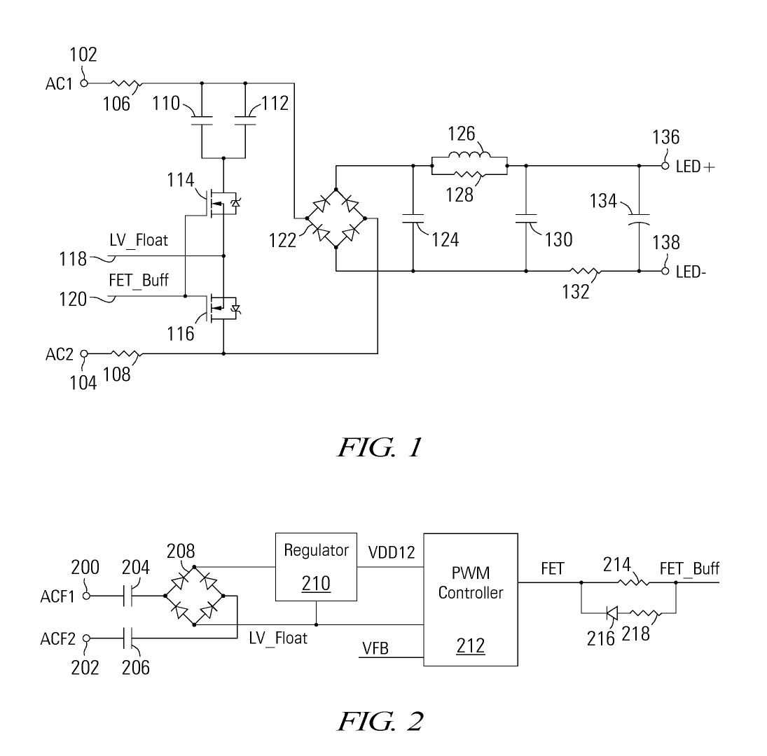

The present invention can use capacitors with varying on time duty cycles to control and dim using conventional electronic ballasts. An illustrative embodiment is shown in FIG. 1 where switches or transistors 114, 116 are used to adjust the on and off times of capacitors 110, 112. Note although two capacitors are shown, any number of capacitors from 1 to a practically large number can be used. Power is received at AC input 102, 104 from a ballast, AC mains or line, or any other suitable power source. A diode bridge 122 or other rectifier can be used to rectify the input power, and can include any type or number of diodes, including multiple diodes in each leg of the bridge to provide the desired power handling capacity. Floating transistors 114, 116 surround a floating ground LV_Float 118 that can be used as a reference at various points of the system. Example signal conditioning components and/or EMI components can be included as desired, such as, but not limited to, capacitors 124, 130, 134, inductor 126, and resistor 128, as well as sensing components such as current sensing resistor(s) (e.g., 132) that can be used, for example, to sense the current through output nodes 136, 138. Fuses (e.g., 106, 108) can also be included as desired.

Turning to FIG. 2, a PWM or one-shot controller is depicted that can be used to close a switch across the power input of FIG. 1 to regulate or turn off the output current and/or power. Optional capacitors 204, 206 can be used to couple to the AC input 200, 202, for example for use with instant start ballasts. In some embodiments, capacitors 204, 206 can be omitted or shorted out, for example with instant start/rapid start/programmed start/etc. electronic ballasts and magnetic ballasts. A rectifier 208 and regulator 210 provide regulated power to PWM controller 212, which provides a pulse or ramp signal based on or controlled in part by a feedback voltage VFB. The rectifier 208 can include one or more diodes per leg in series or parallel or both, etc. The regulator 210 can comprise a linear regulator, switching or combo regulator, etc. In some embodiments, resistor capacitor (RC), etc. networks can be attached to each bi-pin output of the ballast to provide for heater/cathode simulation/emulation/etc. circuits. The PWM controller output is used to control transistors 114, 116 to vary the duty cycle of the input power, connected through diode 216 and resistors 214, 218.

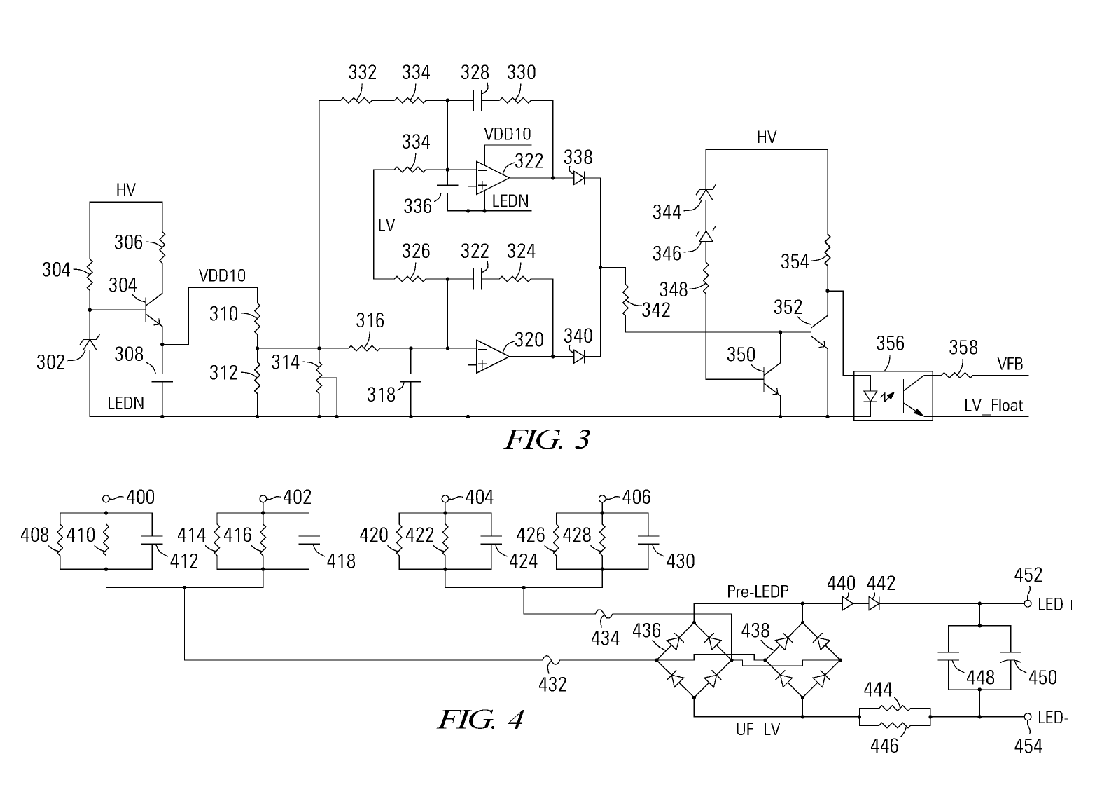

Turning to FIG. 3, an example of a feedback control circuit to provide a constant output current or for other purposes using a setpoint reference signal is depicted in accordance with some embodiments of the invention. A linear regulator including Zener diode 302, BJT 304 and resistors 304, 306 and capacitor 308 can be used, or in other embodiments, switching or other regulators. A voltage divider 310, 312 provides a reference voltage to op-amps 320, 322 for feedback control, modified by sensors, external control inputs, variable resistors, etc as desired (e.g., 314). The feedback can have reversed or inverted polarities if desired. Time constants such as, but not limited to, that provided by resistor 316, capacitor 318 can be applied to the inputs and/or outputs of the op-amps 320, 322 or at any other points in the circuit. An opto-isolator 356 can be used as an isolation or level-shifting circuit between the feedback control circuit and the output voltage feedback signal VFB.

Turning to FIG. 4, a circuit schematic of an example embodiment of a fluorescent lamp LED or HID replacement is depicted where, among other things, shunting is used to set the solid state light output that can be remote controlled and monitored. Inputs 400, 402, 404, 406 represent the two (one on each side for a linear FL and both on the same side for, for example, a four pin PLC lamp) sets of bi-pins for, for example, a ballast and tombstone fluorescent lamp connection system/network. Input coupling components such as resistors 408, 410, 414, 416, 420, 422, 426, 428 and capacitors 412, 418, 424, 430 can be included as desired or needed to ensure proper operation of ballasts, for example to provide heater emulation. Fuses (e.g., 432, 434) can be included. One or more rectifiers 436, 438 can be included, as well as signal conditioning components and/or EMI components can be included as desired, such as, but not limited to, diodes 440, 442, capacitors 448, 450, as well as sensing components such as current sensing resistor(s) (e.g., 444, 446) that can be used, for example, to sense the current through output nodes 452, 454.

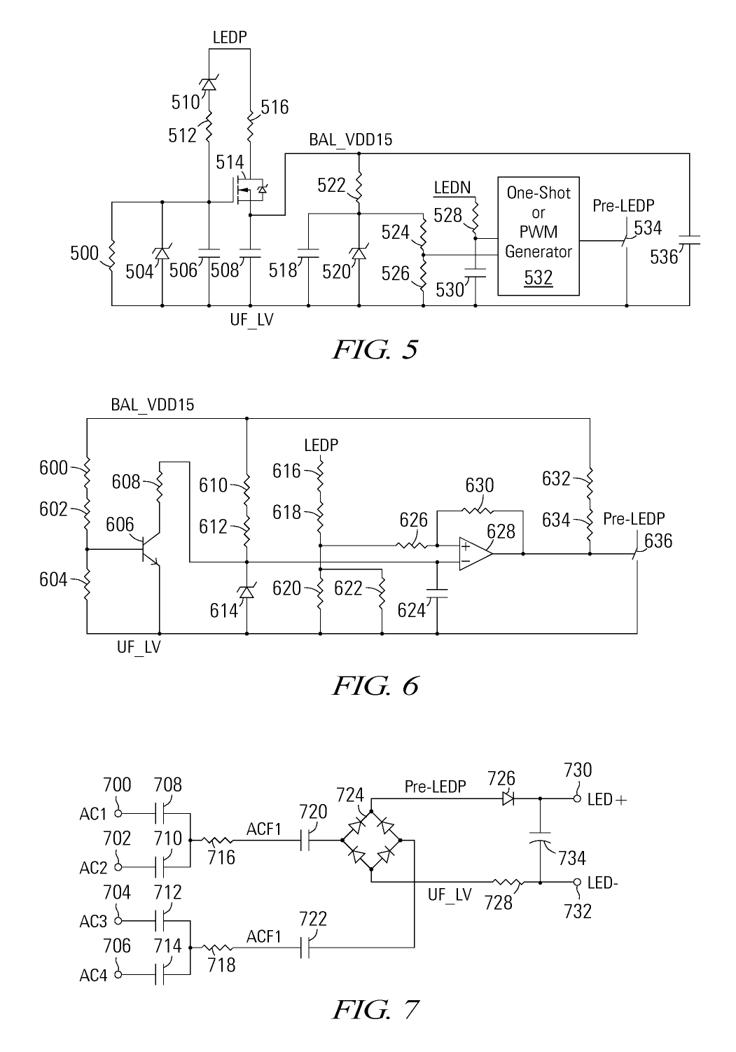

FIG. 5 depicts a one-shot or PWM-based shunt control circuit that can be used with the fluorescent lamp LED or HID replacement of FIG. 4 to provide a voltage turn-on characteristic that is compatible with certain types of ballasts such that a Zener diode or diodes (e.g., 510) holds off the turning on until a specific voltage is reached from the ballast. A regulator circuit (e.g., 500, 504, 506, 508, 512, 514, 516) of any topology can be used to provide a power signal used to power a one-shot or PWM generator 532 through reference circuit 518, 520, 522 and voltage divider 524, 526. This reference is compared with another reference voltage, optionally filtered by time constant 528, 530, and the result controls a shunt switch 534.

Turning to FIG. 6, an over-voltage protection and/or over-temperature protection circuit is depicted that can be used with the fluorescent lamp LED or HID replacement of FIG. 4. An op-amp 628 compares a reference voltage with a feedback voltage, with any suitable temperature-dependent voltage signals and over-voltage signals used to control a shunt switch 636.

The present invention allows automatic, manual, programmable including user-programmable or selectable switchover from linear to duty cycle (e.g., pulse, pulse duration, pulse width modulation (PWM), etc.) or duty cycle to linear regulation as a function of either current or voltage on the load (e.g., OLED, LED, QD, combinations of these, etc,).

Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Also, in some embodiments and implementations of the present invention, part, most or all EMI circuits may be located in a different order than those shown in drawings of example embodiments.

The buck converter could also be a boost-buck, buck-boost, boost, etc. converter. The LED load could be LEDs, OLEDs, QDs, combinations of these, etc. Embodiments of the present invention include a circuit that contains at least one diode, at least one inductor, at least one switching element/switch. The buck converter can have OVP, OTP, OCP, shock hazard/pin safety protection, constant current, etc.

The present invention including the figures depicted above can be used with AC line voltage including but not limited to 80 to 305 VAC 50/60 Hz, 347 VAC 50/60 Hz, 480 VAC, other 50/60 Hz voltages, magnetic and electronic ballasts, low frequency and high frequency ballasts, instant start, rapid start, programmed start, program start, pre-start, warm, cold, hot types of ballasts, etc.

An example of such an embodiment is shown in FIGS. 7-8 in which the circuit can be used for both AC and ballast mode operation. Turning to FIG. 7, a schematic version of the present invention is depicted including inputs 700, 702, 704, 706 for, for example, two pairs of bi-pin connections to a ballast and tombstone in a fluorescent lamp fixture, which can include a buck switching circuit that can be used with both a ballast or AC line which can also be optionally remote controlled and have features including OTP. OVP, SCP, dither, etc. and can be used with all types of ballasts including electronic rapid start, instant start, programmed start, preheat, magnetic, etc. that can be remote controlled and monitored and also has remote control/dimming. Input coupling capacitors 708, 710, 712, 714, 720, 722 and resistors 716, 718 can be included along with, if desired, any other heater emulation or other input conditioning elements in any configuration. One or more rectifiers 724 can be included, as well as signal conditioning components and/or EMI components which can be included as desired, such as, but not limited to, diode 726, capacitors 734, as well as sensing components such as current sensing resistor(s) (e.g., 728) that can be used, for example, to sense the current through output nodes 730,732.

Turning to FIG. 8, a one-shot or PWM-based shunt control circuit and over-voltage protection and/or over-temperature protection circuit is depicted that can be used with the fluorescent lamp LED or HID replacement of FIG. 7. A regulator circuit 800, 802, 804, 806, 808 provides a power signal. A DC reference control circuit 810 provides a voltage setpoint, which is divided in voltage divider 814, 816 and optionally filtered with a time constant 812, 818 and compared against a voltage through optional time constant 820, 822 in op-amp 824 and buffered by transistor 830, resistor 832 before controlling shunt switch 834. Comparator or amp 824, resistors 826 and 832 and transistor 830 comprise and form a one shot that feeds switch 834.

Comparator or op amp, 824, compares a scaled version of the set point value against of representative voltage of the current through the LED. When the voltage at 820 is greater than the voltage at the non-inverting pin of 824, then the output of 824 goes low and discharges capacitor 828 which, in turn, turns off transistor 830 which then switches on switch 834 which then shunts current. When capacitor 828 charges to a voltage sufficient to turn on transistor 830, switch 834 is switched off and no longer shunts current. Diode 726, for example, in FIG. 7 prevents the voltage across the capacitor 734 and the voltage 730-732 across the LEDs, OLEDs, and/or other SSLs from also being shorted out during the time duration that switch 834 is on.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc.

Turning to FIGS. 9-10, examples of a self-contained solid-state fluorescent tube replacement with motion and optionally other sensors incorporated into certain implementations of the present invention are depicted. A tube replacement 900, 1000 can have any form factor to replace a fluorescent or HID lamp and can include power sources, converter circuits, heater emulation circuits, feedback circuits, dimming circuits, user interface circuits, sensor control and integration circuits, LED and/or other light sources, etc. Sensor(s) (e.g., 908, 1009) of any number and type can be directly integrated into the tube replacements 900, 1000 at ends near end caps 902, 1002 or at any other location, such as motion sensors, light sensors, temperature sensors, combination sensors, IOT interfaces, IR receivers and/or transmitters to interface with and/or control other devices, cameras, photosensors, etc. The sensors can include multiple sensors of one type or of multiple types. Bi-pins 904, 906, 1005, 1007 can be provided as needed to connect to the tombstone fixture or other lamp fixture interfaces.

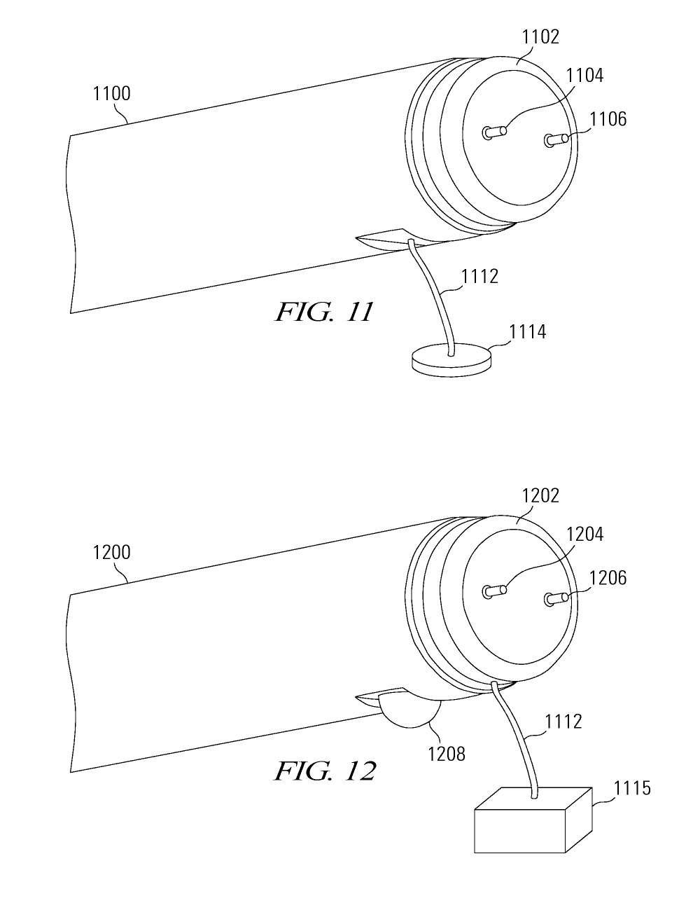

As shown in FIGS. 11-12, in some embodiments of a fluorescent or HID tube replacement 1100, 1200 can include wired connections 1112 to power and/or interface with external sensors 1114, 1115 or other devices or control, enabling the fluorescent or HID tube replacement 1100, 1200 to create a smart home or smart building environment that can be easily installed and easily transferred or moved to another facility. This also enables the fluorescent or HID tube replacement 1100, 1200 to be used to power external devices, greatly simplifying installation and configuration and provisioning of a smart building environment.

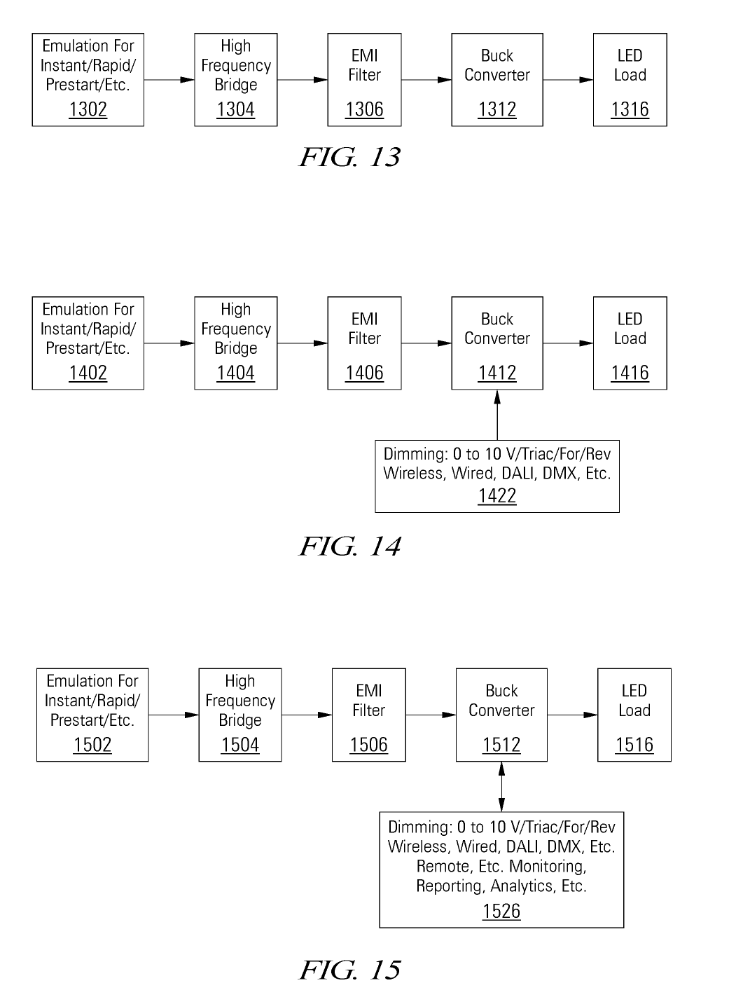

Turning to FIG. 13, a block diagram of an example embodiment of the present invention is depicted that can be used for both AC lines and ballast mode that can be remote controlled and dimmed in both modes. An emulation circuit 1302 can be included to emulate a fluorescent or HID tube for instant/rapid/prestart ballasts to enable or assist the ballast to operate normally when the fluorescent or HID tube has been replaced. A high frequency bridge 1304 rectifies the input signal and an EMI filter 1306 can be included to reduce EMI. A buck converter 1312 converts the input power to the power signal required for the LED and/or other load 1316. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Also, in some embodiments and implementations of the present invention, part, most or all EMI circuits may be located in a different order than those shown in drawings of example embodiments.

Turning to FIG. 14, a block diagram of an example embodiment of the present invention is depicted that can be used for both AC lines and ballast mode that can be remote controlled and dimmed in both modes. An emulation circuit 1402 can be included to emulate a fluorescent or HID tube for instant/rapid/prestart ballasts to enable or assist the ballast to operate normally when the fluorescent or HID tube has been replaced. A high frequency bridge 1404 rectifies the input signal and an EMI filter 1406 can be included to reduce EMI. A buck converter 1412 converts the input power to the power signal required for the LED and/or other load 1416. Any type of dimming control signal 1422 can be received and processed to control the current and/or voltage to the load 1416, such as, but not limited to, optional wall (Triac), 0 to 10 V, powerline (PLC), wireless, DMX and DALI dimming as well as one or more radio protocols including but not limited to 2.4 GHz ones such as Bluetooth. Bluetooth Low Energy, ZigBee, Zwave, WiFi, including mesh, network, etc.

Turning to FIG. 15, a block diagram of an example embodiment of the present invention is depicted that can be used for both AC lines and ballast mode that can be remote controlled and dimmed in both modes. An emulation circuit 1502 can be included to emulate a fluorescent or HID tube for instant/rapid/prestart ballasts to enable or assist the ballast to operate normally when the fluorescent or HID tube has been replaced. A high frequency bridge 1504 rectifies the input signal and an EMI filter 1506 can be included to reduce EMI. A buck converter 1512 converts the input power to the power signal required for the LED and/or other load 1516. Any type of dimming control signal 1526 can be received and processed to control the current and/or voltage to the load 1516, such as, but not limited to, optional wall (Triac), 0 to 10 V, powerline (PLC), wireless, DMX and DALI dimming as well as one or more radio protocols including but not limited to 2.4 GHz ones such as Bluetooth, Bluetooth Low Energy, ZigBee, Zwave, WiFi, including mesh, network, etc. The control signal 1526 can also support remote and/or local monitoring, reporting, analytics, etc.

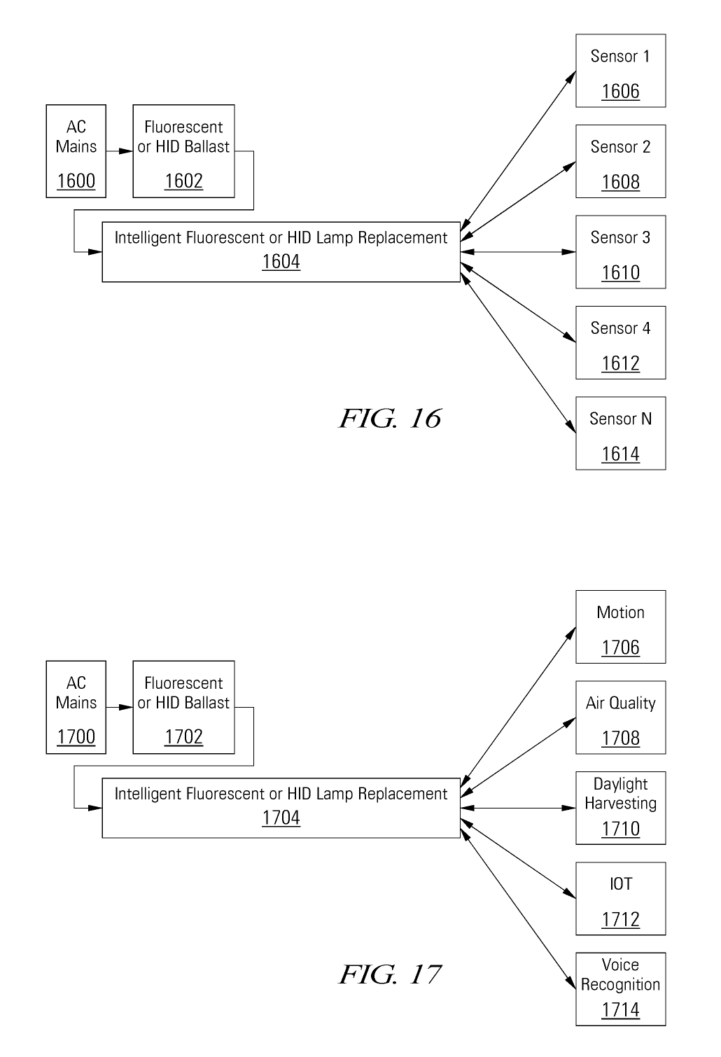

Turning to FIG. 16, a block diagram of a fluorescent lamp LED or HID replacement 1604 is depicted with bi-directional communications with multiple sensors 1606, 1608, 1610, 1612, 1614. Power is received from AC mains 1600 via a fluorescent or HID ballast 1602. The sensors 1606, 1608, 1610, 1612, 1614 can be of one or many types, and are powered by and communicate with the fluorescent lamp LED or HID replacement 1604 to provide information and status, control signals, reporting/monitoring/analytics, etc.

Turning to FIG. 17, a block diagram of a fluorescent lamp LED or HID replacement 1704 is depicted with bi-directional communications with a variety of example sensors, inputs and controllers. Power is received from AC mains 1600 via a fluorescent or HID ballast 1602. Internal and/or external sensors and interfaces of any type can be included, such as, but not limited to, motion sensors 1706, air quality sensors 1708, daylight harvesting systems 1710. Internet of Things interfaces 1712, voice recognition interfaces 1714, as well as any other sensors or interfaces such as microphones, infrared sensors/transmitters, cameras, proximity sensors, accelerometers, temperature sensors, etc. The sensors are intended to be non-limiting representative illustrations.

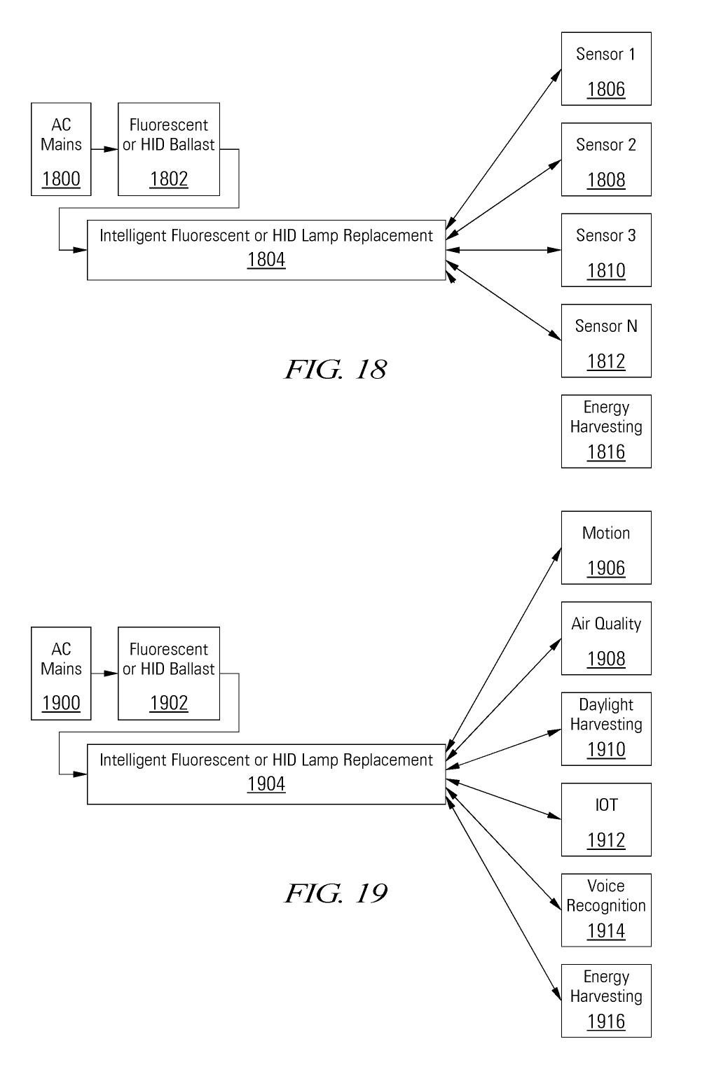

Turning to FIG. 18, a block diagram of a fluorescent lamp LED or HID replacement 1804 is depicted with bi-directional communications with multiple sensors 1806, 1808, 1810, 1812, 1814. Power is received from AC mains 1800 via a fluorescent or HID ballast 1802. The sensors 1806, 1808, 1810, 1812, 1814 can be of one or many types, and are powered by and communicate with the fluorescent lamp LED or HID replacement 1804 to provide information and status, control signals, reporting/monitoring/analytics, etc. Energy harvesting systems 1816 can be used to power the sensors 1806-1814 or other devices, or to supplement power from the fluorescent lamp LED or HID replacement 1804. Energy harvesting includes, but is not limited to, solar and photovoltaic, vibration, mechanical, RF, wireless power transfer including but not limited to inductive coupling power transfer, etc.

Turning to FIG. 19, a block diagram of a fluorescent lamp LED or HID replacement 1704 is depicted with bi-directional communications with a variety of example sensors, inputs and controllers. Power is received from AC mains 1900 via a fluorescent or HID ballast 1902. Internal and/or external sensors and interfaces of any type can be included, such as, but not limited to, motion sensors 1906, air quality sensors 1908, daylight harvesting systems 1910, Internet of Things interfaces 1912, voice recognition interfaces 1914, as well as any other sensors or interfaces such as microphones, infrared sensors/transmitters, cameras, proximity sensors, accelerometers, temperature sensors, etc. Energy harvesting systems 1916 can be used to power the sensors 1906-1914 or other devices, or to supplement power from the fluorescent lamp LED or HID replacement 1904.

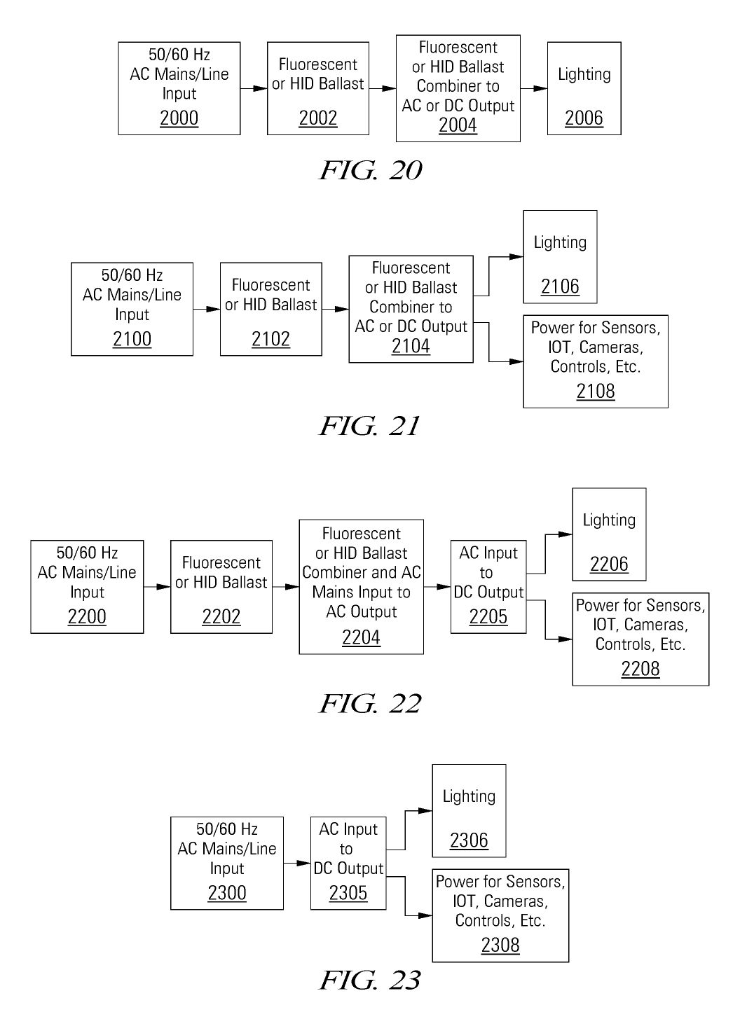

FIGS. 20-31 depict block diagrams of various example embodiments of the present invention that can be used for both AC lines and ballast mode in AC and/or DC power modes that can be remote controlled and dimmed in both modes.

Turning to FIG. 20, a 50/60 Hz AC Mains/Line input 2000 powers a fluorescent or HID ballast 2002 of any type. A fluorescent or HID ballast combiner 2004 can be used to combine the output of multiple ballasts, yielding an AC or DC output. The fluorescent or HID ballast combiner 2004 powers lighting 2006 and/or other loads, sensors, etc.

Turning to FIG. 21, a 50/60 Hz AC Mains/Line input 2100 powers a fluorescent or HID ballast 2102 of any type. A fluorescent or HID ballast combiner 2104 yields an AC or DC output to power lighting 2106 and/or other loads, sensors, etc., such as sensors, IOT, cameras, controls, 2108 etc.

The example embodiments of FIGS. 20-21 are configurations for the present invention in which the ballast directly or indirectly provides power for one or more light/lighting and also in the figure above, power for sensors, detectors, IOT, cameras, controls, etc. Various power sources from, for example, but not limited to, 120 VAC or higher 50/60 Hz. 48 VDC, 24 VDC, 12 VDC, and/or 5 VDC, etc. are provided to lighting and sensors, IOT, controls, etc. This is an example of the present invention (above) in which the combiner and the AC output and/or DC output are combined into one unit.

Turning to FIG. 22, a 50/60 Hz AC Mains/Line input 2200 powers a fluorescent or HID ballast 2202 of any type. A fluorescent or HID ballast combiner 2204 yields an AC output (e.g., 120 VAC, 240 VAC or 277 VAC 50/60 Hz), provided to an AC to DC converter 2205 that generates DC output power to the lighting 2206 and power to the sensors, IOT, accessories, controls, communications, 2208 etc.

Turning to FIG. 23, in some embodiments a 50/60 Hz AC Mains/Line input 2300 is connected directly to an AC to DC converter 2305 that generates DC output power to the lighting 2306 and power to the sensors, IOT, accessories, controls, communications, 2308 etc. In this example the ballast and the ballast combiner has been bypassed such that the lighting and sensors, IOT, controls, etc. are directly connected/plugged in to the AC mains. Note in some embodiments of the present invention, the lighting including but not limited to SSL/LED lighting can be AC input lighting, that is, lighting that accepts and can run/operate on an AC input.

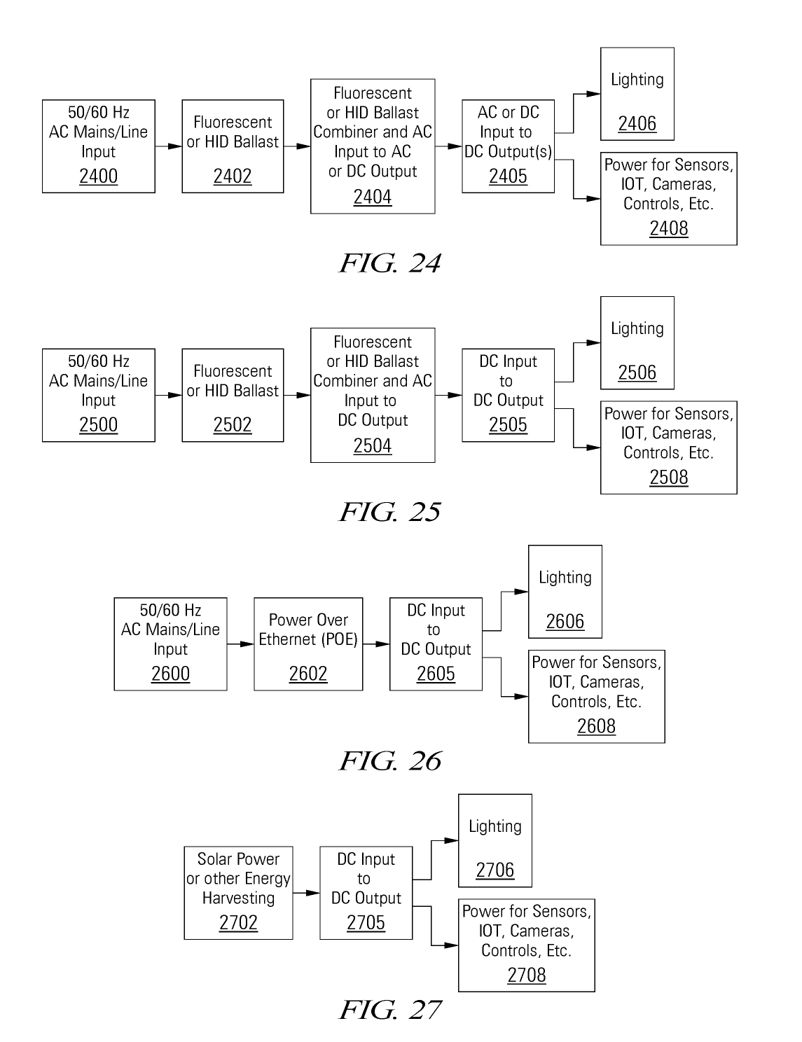

Turning to FIG. 24, a 50/60 Hz AC Mains/Line input 2400 powers a fluorescent or HID ballast 2402 of any type. A fluorescent or HID ballast combiner 2404 yields an AC output (e.g., 120 VAC, 240 VAC or 277 VAC 50/60 Hz), provided to an AC or DC to DC converter 2405 that generates DC output power to the lighting 2406 and power to the sensors, IOT, accessories, controls, communications, 2408 etc. The ballast combiner 2404 thus produces an AC and/or DC output that is fed into an AC or DC, respectively, input unit 2405 that provides appropriate DC output(s) to the lighting 2406 and other sensors (2408), IOT, controls, cameras, communications, advertisements, smart coupon and discount(s) to, for example, but not limited to, customers, clients, passerby, loyalty customers, etc.

Turning to FIG. 25, a 50/60 Hz AC Mains/Line input 2500 powers a fluorescent or HID ballast 2502 of any type. A fluorescent or HID ballast combiner and AC input to AC or DC output circuit 2504 yields an AC output (e.g., 120 VAC, 250 VAC or 277 VAC 50/60 Hz), provided to an AC or DC to DC converter 2505 that generates DC output power to the lighting 2506 and power to the sensors, JOT, accessories, controls, communications, 2508 etc. The ballast combiner 2504 thus produces a DC output that is fed into a DC input unit 2505 that provides appropriate DC output(s) to the lighting 2506 and other sensors (2408), IOT, controls, cameras, communications, advertisements, smart coupon and discount(s) to, for example, but not limited to, customers, clients, passerby, loyalty customers, etc.

Turning to FIG. 26, a 50/60 Hz AC Mains/Line input 2600 powers a Power Over Internet (POE) circuit 2602 that yields a DC output. A DC to DC converter 2605 generates DC output power to the lighting 2606 and power to the sensors, IOT, accessories, controls, communications, 2608 etc. Thus, the ballast and the ballast combiner has been bypassed such that the lighting and sensors, IOT, controls, etc. are directly connected/plugged into DC to DC converter that, itself, is plugged into a POE lighting system and/or supply and replaces the ballast or ballast(s) and the power combiner.

Turning to FIG. 27, a Solar Powered source lighting system 2702 yields a DC output. A DC to DC converter 2705 generates DC output power to the lighting 2706 and power to the sensors, IOT, accessories, controls, communications, 2708 etc. Thus, the ballast and the ballast combiner has been bypassed such that the lighting and sensors, IOT, controls, etc. are directly connected/plugged into DC to DC converter that, itself, is plugged into a Solar Powered source lighting system and replaces the ballast or ballast(s) and the power combiner.

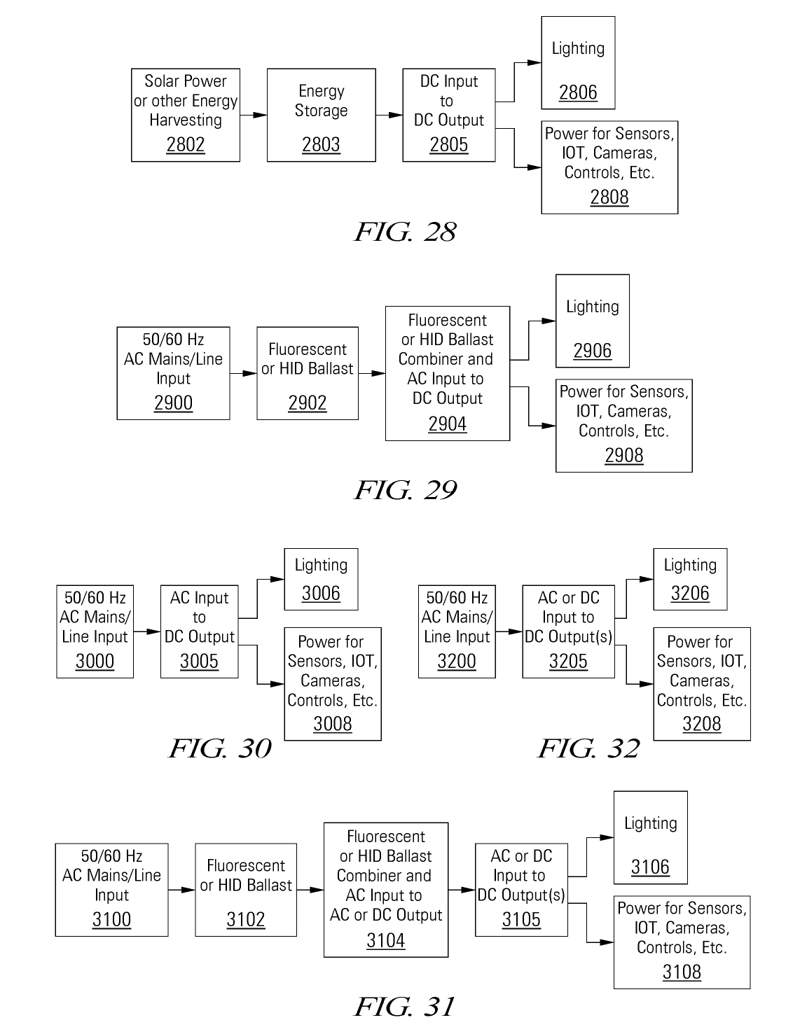

Turning to FIG. 28, a Solar Powered source lighting system 2802 yields a DC output to an energy storage device 2803 (e.g. batteries, fuel/chemical storage, etc.). A DC to DC converter 2805 generates DC output power to the lighting 2806 and power to the sensors, IOT, accessories, controls, communications, 2808 etc. Thus, the ballast and the ballast combiner has been bypassed such that the lighting and sensors, IOT, controls, etc. are directly connected/plugged into DC to DC converter that, itself, is plugged into a Solar Powered source lighting system and/or supply including energy storage including but not limited to such as batteries, fuel and chemical storage and replaces the ballast or ballast(s) and the power combiner.

Turning to FIG. 29, a 50/60 Hz AC Mains/Line input 2900 powers a fluorescent or HID ballast 2902 of any type. A fluorescent or HID ballast combiner and AC input to DC output circuit 2904 yields a DC output to power lighting 2906 and/or other loads, sensors, etc., such as sensors, IOT, cameras, controls, 2908 etc.

Turning to FIG. 30, in some embodiments a 50/60 Hz AC Mains/Line input 3000 is connected directly to an AC to DC converter 3005 that generates DC output power to the lighting 3006 and power to the sensors, IOT, accessories, controls, communications, 3008 etc. In this example the ballast has been bypassed and the combiner and the AC output and/or DC output that are combined into one unit is directly plugged into the AC mains/line input with the ballast combiner not used and only the AC to DC portion used.

Turning to FIG. 31, a 50/60 Hz AC Mains/Line input 3100 powers a fluorescent or HID ballast 3102 of any type. A fluorescent or HID ballast combiner 3104 yields an AC output (e.g., 120 VAC, 310 VAC or 277 VAC 50/60 Hz), provided to an AC or DC to DC converter 3105 that generates DC output power to the lighting 3106 and power to the sensors, IOT, accessories, controls, communications, 3108 etc. The ballast combiner 3104 thus produces an AC and/or DC output that is fed into an AC or DC, respectively, input unit 3105 that provides appropriate DC output(s) to the lighting 3106 and other sensors (2408), IOT, controls, cameras, etc.

Turning to FIG. 32, in some embodiments a 50/60 Hz AC Mains/Line input 3200 is connected directly to an AC or DC to DC converter 3205 that generates DC output power to the lighting 3206 and power to the sensors, IOT, accessories, controls, communications, 3208 etc. In this example the ballast has been bypassed and the combiner and the AC output and/or DC output that are combined into one unit is directly plugged into the AC mains/line input with the ballast combiner not used and only the AC to DC portion used.

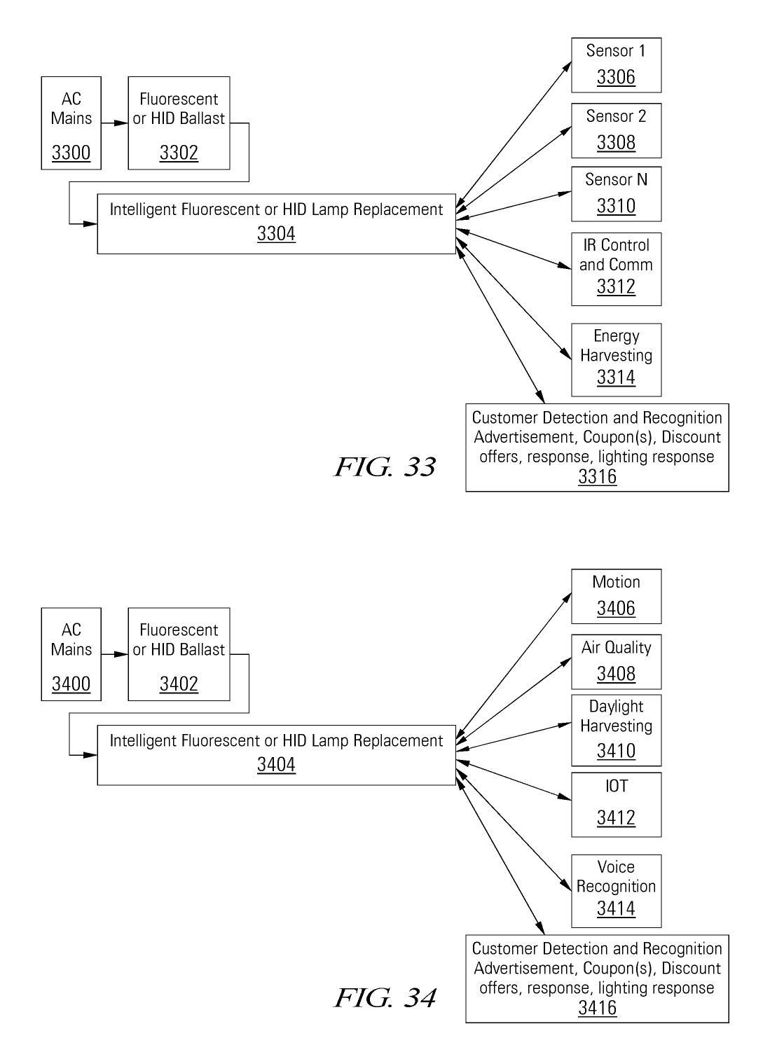

FIGS. 33-34 depict block diagrams of fluorescent lamp LED or HID replacements with bi-directional communications with a variety of example sensors, inputs, controllers and power sources as well as with customer detection/response and/or advertisement.

Turning to FIG. 33, a block diagram of a fluorescent lamp LED or HID replacement 3304 is depicted with bi-directional communications with multiple sensors 3306, 3308, 3310, IR control and communications circuit 3312, energy harvesting system 3314, and customer detection system 3316. Power is received from AC mains 3300 via a fluorescent or HID ballast 3302. The sensors 3306, 3308, 3310, 3312, 3314 can be of one or many types, and are powered by and communicate with the fluorescent lamp LED or HID replacement 3304 to provide information and status, control signals, reporting/monitoring/analytics, etc. Energy harvesting systems 3316 can be used to power the sensors 3306-3314 or other devices, or to supplement power from the fluorescent lamp LED or HID replacement 3304. Energy harvesting includes, but is not limited to, solar and photovoltaic, vibration, mechanical, RF, wireless power transfer including but not limited to inductive coupling power transfer, etc.

Turning to FIG. 34, a block diagram of a fluorescent lamp LED or HID replacement 1704 is depicted with bi-directional communications with a variety of example sensors, inputs and controllers. Power is received from AC mains 3400 via a fluorescent or HID ballast 3402. Internal and/or external sensors and interfaces of any type can be included, such as, but not limited to, motion sensors 3406, air quality sensors 3408, daylight harvesting systems 3410, Internet of Things interfaces 3412, voice recognition interfaces 3414, and customer detection system 3316 as well as any other sensors or interfaces such as microphones, infrared sensors/transmitters, cameras, proximity sensors, accelerometers, temperature sensors, etc.

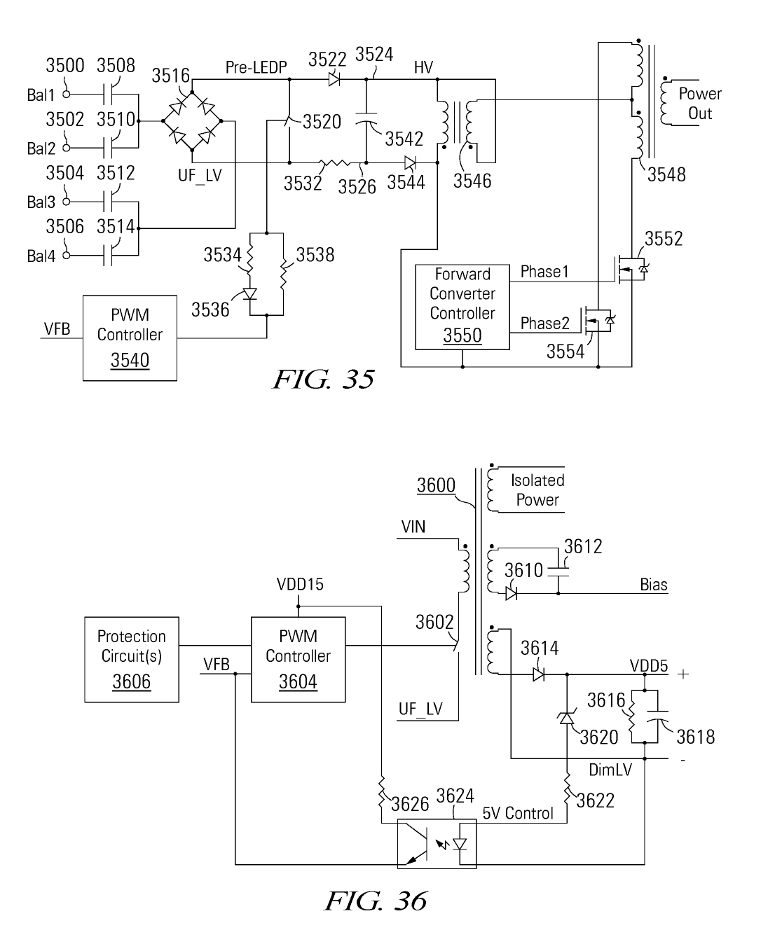

Turning to FIG. 35, example embodiment of a fluorescent lamp LED or HID replacement is depicted with PWM or one-shot shunt control and forward power conversion. The intelligent and smart controls include installed hardware such as wall or portable dimmers and on/off/sequence/etc. switches or mobile devices (e.g., smart phones, tablets, laptops, desktops and servers) also simplify the installation, configuration, control, and analytics aspects of an intelligent lighting system such that it can be self-commissioning.

As depicted in FIG. 35, the output of an electronic instant start ballast is shown with four outputs 3500, 3502, 3504, and 3506 feed to capacitors 3508, 3510, 3512 and 3514 which permit the four outputs of the ballast to be combined and fed into high frequency diode bridge 3516 with the rectified positive output of diode bridge 3516 going to the top of switch 3520 and anode of diode 3522. In the example shown in FIG. 35, a PWM control signal is applied to switch 3520 which, when turned on, shunts the current from the combined ballast outputs 3500, 3502, 3504, and 3506. The PWM can be feedback controlled using one of several nodes and signals including but not limited to the voltage at HV 3524, the current through resistor 3532, or the voltage, current or power out through the secondary of transformer 3548. As also shown in FIG. 35, forward-converter controller 3550, transistors 3552 and 3554, and transformer 3548 form a forward-converter that is used to provide at one or more galvanic isolated output power to power, for example, the lighting, sensors and IOT, etc.

As depicted in FIG. 35, in some embodiments, an optional series inductor 3546 which is commonly called a feed-choke or series inductor with also an optional capacitor 3542 from HV 3524 to LV 3526 a diode 3544 in series with the second winding of the feed-choke to circuit point 3526 can be inserted between HV and the center tap of the transformer 3548 to maintain a continuous current through the circuit under all conditions.

Note in some embodiments of the present invention, the current shunting is performed on the secondary side of transformer 3548 of FIG. 35. In yet other embodiments of FIG. 35, there are no inductor or forward-converter transformer and the combined power is provided across capacitor 3542.

As depicted in FIG. 36, another version of the present invention is illustrated in which PWM controller 3604 and associated protection circuitry 3606 (which can be part of or an integrated circuit) is used to drive switch 3602 which, as illustrated in FIG. 36 forms, together with transformer 3602, a flyback isolated power converter that is used to provide galvanic outputs at one or more galvanic isolated output power to, for example, in this non-limiting case, power, for example, but not limited to, the lighting, sensors and IOT, etc. The winding attached to diode 3610 and capacitor 3612 is used to provide power to, for example, but not limited to, the microcontroller (etc.), the communications radio (i.e., WiFi, ZigBee, Bluetooth, etc.) for the present invention in addition to other windings that provide isolated power for the lights, the sensors, the detectors, the IOT, the controls, etc. The winding attached to diode 3614 which is attached to Zener diode 3620 which is attached in series at the anode end of Zener diode to resistor 3622 such that when the voltage at the cathode of Zener diode 3622 exceeds the Zener voltage of Zener diode 3622 current flows including through the optocoupler 3624 which provides isolated feedback to PWM controller to reduce the duty cycle on switch 3602 thereby regulating the voltage at VDD5 and providing for power to both the SSL including but not limited to LEDs, OLEDs, QDs, etc. as well as the sensors, IOT, controls, etc.

Various embodiments provide one or more of the following features:

Remote control of motorized aiming including wired and wireless (i.e., powerline control, RS232, USB, SPI, SPC, I2C, etc., WiFi, Bluetooth, ZigBee, IEEE 801, ISM, infrared (IR), etc.) so as to move the light source up and down, left and right, more or additional axes of motion/rotation, etc., to monitor and measure spaces and movement, direction, speed, velocity, acceleration, etc. of people, animals, objects, etc.

The present invention can be dimmed and turned on/off remotely. The present invention can be tilted/aimed/pointed/flipped/closed/etc. remotely. The present invention can be color changing (i.e., include RGB) in addition to various colors of white, color temperatures of white, full spectrum lighting, etc. Embodiments of the present invention can use RGB color changing plus white light (i.e., WRGB) and/or RGB color changing plus amber light (i.e., RGBA) and/or RGB color changing plus white and/or amber light (WRGBA), etc., including combinations of LED, OLED, QD, other SSL, other lighting, etc. and/or combinations of these. etc. including N separate wavelength or phosphor coated colors where N>0 and could be relatively large such as, but not limited to, 16, 32, 64, 128, etc. or 1, 2, 5, 10, 20, 50, 100, . . . etc.

The present invention can be controlled by smart phones (i.e., iPhones, Androids, Samsung), tablets (iPads, iPods, Androids, Kindle, Samsung, etc.), laptops, desk top computers, etc. to connect and communicate with including in bi-directional or multi-directional modes.

The present invention can have integrated built-in battery back-up/storage.

The present invention can be used as an emergency, camping, personal or portable light and can be used as an emergency beacon.

The present invention can respond to/interact with near field communication (NFC) and/or radio frequency identification (RFID) tags, readers, etc. and other such signals and systems

The present invention can be solar power and/or solar charged.

The present invention can be used as an alarm clock in numerous modes including an embodiment where the light comes on gradually and increases in intensity while, for example, rotating from a horizontal facing down light source direction to either a vertical light facing direction or a horizontal light facing up direction or alternate between various facing directions while also providing optional sound (words, alarms, music, etc.).

The present invention can be voice activated and controlled.

The present invention can provide monitoring including input and output current, voltage, power, etc. (analytics) and also respond to motion, sound, light, etc. and report and store any or all monitoring information, conditions, etc.

The present invention can provide color changing remotely and also be sound activated including changing colors to sound, music, temperature, vibration, etc.

The present invention can be implemented to track sound, motion, light, vibrations, etc.

The present invention can be, but not limited to, a desk lamp, a track lamp, a task lamp, a table lamp, a floor lamp, a room lamp, a downlight, a can light, sconce, pendant, etc.

The present invention can be programmed to turn on or off by time of day, day of week, event-based including dawn or dusk, etc. The present invention can use motion sensors that can do, for example, multiple duties—turning on/off lights, alerting that there are people there, heating or cooling spaces, being part of a burglar alarm, etc.

The present invention can track, report, store, display, show, log, control, manage, control, monitor, respond, feedback, distribute, modify, interact, allocate, respond, adapt, the position and angle, etc. either dynamically or statically or both of the lamp, including of the motors, actuators, light, power, and related items, etc.

The present invention can use sensors of any type including but not limited to position, acceleration, velocity, angular, height, incline, decline, slope, color temperature, light, pressure, touch, mechanical, vibration, strain, stress, etc.

The present invention can use storage of lighting direction, to remember previous settings to repeat again and again and to also learn and store new ones; to store favorites; to make new favorites; etc.

The present invention including lamp embodiments can sway and move including in arbitrary directions to various types of stimuli including, but not limited to, sounds, music, noise, vibrations, facial expressions, face recognition, biometrics, body and health conditions using sensors, wearables, medical devices, etc., light, movement, pre-programming, user-programming, remote programming, etc.

Voice commands, sound control, color sensors, microphones, tones, audio, volume level, etc. can be used with the present invention.

The present invention can use solar conversion to store energy to turn on later.

The present invention can be, or can work, interact, connect, communicate, etc. with but is not limited to, a task lamp, desk lamp, a wall lamp, a can lamp a ceiling lamp, a track lamp, a lamp fixture, a sconce lamp, a pendant lamp, an accent lamp, under counter lamps, over counter lamps, cabinet lamps, part of a multi-lamp fixture, part of a fan lamp, a bed lamp, a reading lamp, a floor lamp, a bed headboard lamp, a bed footboard lamp, a table lamp, a multi-purpose lamp, a bathroom lamp, a vanity lamp, a kitchen lamp, a mirror lamp, a picture lamp, a dresser lamp, a bathroom lamp, a closet lamp, a bath lamp, a shower lamp, combinations of these, multiples of these, etc.

The present invention offers healthy, economical, energy-efficiency benefits. With the energy savings and the potentially energy-neutral nature of the present invention there are both economical and human health benefits associated with adopting the present invention.

The present invention also may improve human health when used in certain circumstances such as light therapy, in hospitals including children hospitals, critical care, intensive care, neonatal, maternity, short term and long term care, and psychiatric hospitals, schools, office environments and buildings to alleviate anxiety and tension with soothing color tones, choices and intensities, as a wake-up aid to naturally wake due to an increase in light exposure of appropriate wavelengths, and in other capacities such as streetlights and street signs where different colors/tones/amplitudes/hues, etc. of light may be beneficial.

The present invention may include lights such as LEDs, OLEDs, QDs, and in certain situations, fluorescent lighting and even, in certain cases, incandescent bulbs, etc. on the IR modules and may also employ solar cells to assist in supplying power and charging, or to fully power the device. Power from the solar cells may also be applied back to the grid to supply power/energy elsewhere or to be used throughout the home or building to power other devices or to be provided back to the electrical grid. In some embodiments of the present invention batteries may also be incorporated into the lighting. The present invention can provide full spectrum or selected user or programmed partial spectrum lighting, for example but not limited to, that changes predominant wavelengths/colors depending on the time of day or night and can be dimmed up, for example, in the morning and dimmed down at night and bedtime. Such lighting can be used for producing increased health, immunity to diseases, productivity, learning and focus, and other health benefits for hospitals, schools, libraries, convalescent homes, assisted living, colleges and universities, dormitories, office and other buildings of all kinds, etc.

The present invention may be used to provide emergency lighting in hospitals, schools, libraries, convalescent homes, assisted living, colleges and universities, dormitories and buildings of all kinds. The invention may also be used as an emergency beacon where lights and sounds may sound when disasters or emergencies occur such as fires, earthquakes, tornadoes, floods, and any other event when an alarm is needed. The present invention also may receive signals from the emergency broadcast systems and radio weather stations and other sources to further display information about current emergency conditions. Units may communicate to other units in the nearby geographical area to alert of any current danger or emergency situation. The present invention may also include sensors such as those used to detect temperature, smoke, CO, CO₂, propane, natural gas, and other airborne particles/chemicals to further provide safe environment monitoring in any situation.

To ensure that the IR transmitter or IR transmitter array is visible to any and all devices in the current area, the IR unit may employ gimbals, servo motors, stepper motors, linear motors and any type of IR lens such as Fresnel, convex, concave, aspheric, achromatic, ball, half-ball, plano-convex and any other lens to create omnidirectional sensitivity to the IR sensor or IR sensor arrays.

The present invention may employ the reflective mirror-like surface of certain OLEDs structures and devices (which is sometimes dependent on construction and, for example, choices of materials used, for example, for the ohmic and/or electrode contacts) as a light reflecting surface for providing directional light from another light source such as an LED, and it may also be used as a mirror surface for a number of purposes including but not limited to reflecting light from, for example, other SSL including LEDs. An example implementation of this is use in a vanity mirror that reflects normal visible light when the OLED is turned off, but illuminates when it is turned on that, for example, can also wavelength/color change from white or blue at wake up to amber before bedtime. Another example is combination light containing one or more each of OLEDs and LEDs each of which can be independently controlled, dimmed and monitored, etc.

The present invention is not limited to controlling any single device and is capable of connecting to virtually an unlimited number of devices. Likewise multiple solid state lamp/lighting devices may be controlled by a single IR unit with one or more IR emitters or through any single or more than one phone/tablet/computer/smart device, etc. In some embodiments of the present invention, fluorescent lamp replacements are provided including but not limited to all types of HID, T8. T12, and/or T5 linear solid state lighting including LED, OLED, QD, etc. combinations of these, etc. In some embodiments of the present invention, the wireless or wired implementation may be used to provide dimmable, color/wavelength-changing, full or partial spectrum selectable and programmable lighting that can also have IR LED emitter incorporated into the solid state lighting replacement for fluorescent tubes such that one or more IR LEDs at different angles, positions, locations for example on linear fluorescent tubes may be used to remotely wired and/or wirelessly control IR remote control heaters, coolers, air conditioners, humidifiers, televisions, DVD, DVR, VHS, Blu-ray players and recorders, cable and/or satellite receivers, CD players and recorders, other audio-visual and entertainment equipment, etc. In other embodiments of the present invention, lighting that is directly plugged into the AC lines may also may use powerline, wireless and/or wired interfaces that may be used to provide dimmable, color/wavelength-changing, full or partial spectrum selectable and programmable lighting that can also have IR LED emitter incorporated into the solid state lighting replacement for fluorescent tubes and all types of HID lamps including those discussed herein such that one or more IR LEDs at different angles, positions, locations may be used to remotely wired or wirelessly control IR remote control heaters, coolers, air conditioners, humidifiers, televisions, DVD, DVR, VHS, Blu-ray players and recorders, cable and/or satellite receivers, CD players and recorders, other audio-visual and entertainment equipment, etc.

The present invention allows automatic, manual, programmable including user-programmable or selectable switchover from linear to duty cycle (e.g., pulse width modulation (PWM)) or duty cycle to linear regulation as a function of either current or voltage on the load (e.g., OLED. LED, QD, other solid state lighting, combinations of these, etc.)

Embodiments of the present invention can track user movements and, for example, light and/or heat the way using for example, but not limited to, motion, proximity, RF, RFID, NFC, heat, temperature, sound, pressure, displacement, radar, ultrasonic, infrared, velocity, acceleration, thermal, etc. combinations of these, etc.

In some embodiments, panel lighting is provided including, but not limited to, phosphorescent OLED lighting panels. OLEDs which offer a thin, lightweight, energy-efficient and large-area diffuse source of lighting with excellent visual quality. Compared to fluorescent lighting (FL), OLED lighting panels do not contain hazardous materials. There are aesthetic and visual effects to OLED lighting that are not easily possible to replicate with fluorescent lighting or LEDs. As with LEDs, phosphorescent OLED lighting devices are current controlled devices. To achieve innovative and imaginative lighting products consisting of multiple panels including non-rectangular shapes, the power supplies can be configured to fully support OLED applications and provide over-current (OCP), over-voltage (OVP), over-temperature (OTP) and short circuit protection (SCP). Also, these power supplies are amenable in some embodiments to form fit applications for OLEDs. Both isolated and non-isolated power supplies for OLEDs support both white light, white-changing and color tunable red/green/blue (RGB) modes of operation. The power supply and design avoids localized heating that may lead to localized degradation of the OLEDs, especially the blue OLEDs, resulting in an unattractive localized yellowing of the part OLED panel(s) in the proximity of the power supply. In some embodiments, the smart drivers, can support, among others, optional wall (Triac). 0 to 10 V, powerline (PLC), wireless, DMX and DALI dimming as well as one or more radio protocols including but not limited to 2.4 GHz ones such as Bluetooth, Bluetooth Low Energy, ZigBee, Zwave, WiFi, including mesh, network, etc. In addition to versions that support white light dimming via smart phones, tablets, iPods, iPads, iPhones, Android devices, Kindles, computers, etc., RGB, WRGB, WRGBA, RGBA, etc. color/mood changing LED, OLED, QD and/or other SSL panels are also supported via the same interfaces and mobile/computer devices which can also provide white light. Examples of control and monitoring system using iPhones, iPads and iPods to control and monitor the light color and light (dimming) level are showed below. In other embodiments of the present invention blue and amber LEDs, OLEDs, QDs, other SSL, etc., and/or combinations of these, etc. can be used to provide white color as well as blue color or amber color so as to provide appropriate lighting for various times of the day which could, for example, support healthy lighting options including lighting to support circadian rhythms, seasonal affective disorder (SAD), etc. In an example embodiment, blue and amber OLEDs can be integrated and incorporated into the same lighting panel and each color is independently controllable such that the blue and amber OLEDs—or other lighting sources such as quantum dots (QDs)—can be independently controlled, adjusted, dimmed, turned on or off, etc. for example by having one or more separately addressable electrodes, contacts, etc. For example, the lighting can be set to white (or blue wavelength/color-enriched) in the morning and set to amber at night for people and animals on a more typical circadian rhythm cycle and the lighting can be set to white (or blue wavelength/color-enriched) in the afternoon, or night or other appropriate time(s) and set to amber at later night or late night (with the time being dependent on the individual's particular schedule including but not limited to work schedule, etc.) for people and animals on a non-normal circadian rhythm cycle.

This example embodiment of a RGBW and optionally, for example, RGBWA and power management control and monitoring system can operate with virtually any smart phone, tablet, laptop, computer, server, etc. to, for example, dynamically separately select and control any number of lights including controlling light level (dimming), power factor, power/energy usage (i.e., kWH), input and output current, voltage, etc. The cost of ownership and the cost of implementation are relatively low for this system yet extremely flexible and powerful including high efficiency low and high power drivers that are adaptable and support many forms of dimming, monitoring and control. Graphical user interface (GUI) pages and user-interface (UI) as well as a very large number of user-adjustable and selectable and custom colors can be used with the present invention.

Unlike simple infrared controlled RGB lightstrips, ropes and the likes with limited color choices and dimming levels, the present RGB lighting allows for high resolution 8-bit to 12-bit (256 to 1024, 2048, 4096, etc.) or higher resolution color levels per RGB channel and with innovative ways to interactively and dynamically user-select the resolution and dimming level. The present invention can also be used for WRGB. WRGBA, RGBA, etc. lightstrips, strings, ropes, etc.

Highly innovative and novel flexible and adaptable OLED or QD large or larger area replacements for fluorescent lamp luminaire retrofitting including both ballast-less (i.e., OLED power supply directly connected to AC lines) replacement and ‘drop-in’ socket replacement (i.e., HID, T-8 or T-12, T5, T4, PLC, etc. OLED power supply directly connected to either a magnetic or electronic ballast in place of the fluorescent lamp tube)—are provided, such as the example T8 or T12 fluorescent lamp conversion using an OLED and/or LED retrofit ‘kit’ which, for example, can be made up of either WOLED or RGB OLED panels and in some implementation LED panels that are ‘stitched’ together to form a flexible area panel. In this example embodiment, four 4 foot long T8 FLs are replaced by OLED area lighting which may be a single panel or a group of stitched panels with an OLED power supply that is designed to plug either directly into the ballast(s) for the T8 FLs or into the AC mains (or both) so as to make it easier to retrofit and install (when the ballast eventually fails, the ballast can be removed and the OLED power supply can be plugged directly into the AC lines. Other embodiments can include other SSL including but not limited to LED. OLED, QD, etc., combinations. etc. of these. The OLED/LED/QD/SSL retrofit including the power supply can be hung/suspended (like a false ceiling) from the FL luminaire or, for example, the OLED/LED/QD/SSL power supply can be inserted in place of the ballast and the OLED/LED/QD/SSL stitched panel can be attached/suspended from the OLED/LED/QD/SSL power supply and drivers. The present invention can also be used with Edison sockets such as A-lamps, PAR 30, PAR 38, MR 16, etc. as well as high intensity discharge (HID) including but not limited to sodium discharge lamps, mercury vapor lamps, metal halide (MH) lamps, ceramic MH lamps, sodium vapor lamps, xenon short-arc lamps, ultra high pressure lamps (UHPs), other types of gas and metal-halide and/or metal salts, etc. Edge emitting solid state lighting (SSL) including edge emitting LEDs and/or Edge-Lit LEDs can be used with the present invention.

Another embodiment provides for highly flexible and adaptable SSL/LED/OLED/QD replacement area lighting that in some embodiments is extremely easy to install and suspend with gravity leveling the SSL/LED/OLED/QD panels and the associated power supply and drivers supported by, for example, the fluorescent luminaire/fixture by a number of secure methods. In addition, the OLED panels do not need diffusers typically used with fluorescent luminaires. Also, innovative color changeable RGB (or RGBW or RGBWA, etc.) OLED and/or QD and/or LED fluorescent replacement and retrofitting lighting (with associated OLED RGB power supplies) can be readily implemented with this approach that can be dual or more use (i.e., white or user-selectable color) without compromising performance, efficiency, efficacy, etc. In some embodiments, an OLED or, for example, an OLED/LED A-lamp can swivel about the axis of the socket. The internal power supply is contained within the socket and can be dimmable, high efficiency and high PF. In some embodiments, a white LED and an amber OLED are used to provide white light ‘daylight’ and amber light ‘nightlight’ to support, for example, circadian rhythms and other health effects at work places, homes, hospitals, etc.

In some embodiments, a vertical version of the OLED or LED/OLED A-lamp is provided with the internal OLED and LED drivers inside the A26 lamp socket and a round plastic cover cylinder attached between the socket on the OLED panel. Another version of the OLED A-lamp includes two back-to-back OLED panels powered by internal driver(s). The internal drivers are dimmable, high efficiency and high PF. Embodiments of the present invention may also use motors, actuators. etc. to tilt, move, angle. etc. the OLED (or LED or both) lighting. In other embodiments of the present invention, the OLEDs may be replaced or augmented with either white LEDs (or any other color) or RGB LEDs to perform the T8, T12, T5, U shaped or other fluorescent lamp replacement, etc. Other embodiments of the present invention may employ wireless power transfer such as inductive coupling or resonant coupling to remotely power the OLEDs or LEDs.

The invention can support all types of lighting solutions including LEDs. CFLs, incandescent, halogen, xenon, HID and other light sources including other SSLs for the purpose of but not limited to providing light in emergency situations such as lighting that directs towards building exits, providing emergency light for critical operations, or any other uses where light is required for emergency or non-emergency needs.

Lighting may be controlled, dimmed, selected, monitored by wireless (including but not limited to Bluetooth, WiFi, ISM, IEEE 801, 2.4 GHz, etc.) or wired (DMX, DALI, RS 232, RS 485, serial, SPI, U2C. USB, etc.) means by the home automation system.

Smart T8, T5, T12, CFL, other fluorescent lamps types, etc., E26, E27, A-lamp, MR-16, GU-10, PAR 30, PAR 38, R 30, 2×2, 2×4, 2 ft.×2 ft., 2 ft.×4 ft., 1 ft.×3 ft., 3 ft.×1 ft., ½ ft.×2 ft., ½ ft. by 4 ft., etc. panels, smaller, larger custom, other sizes, sizes to fit into existing luminaires and fixtures, etc., down light, can light, under cabinet, over cabinet, sconce, troffer, pendant fixtures, chandelier fixtures, under cabinet, over cabinet, track lighting, etc. Lighting panels used or powered in the invention can include waveguided, edge emitting, edge lit, back lit, direct lit, directly lit, surface lit, surface emitter, and edge emitter, combinations of these, etc. LED lighting and lighting panels, etc and combinations of these. The lighting panels can be white, RGB, RGBW, RGBA, RGBAW, etc., combinations of these, etc.

If the power is too high for the heat sink in lighting, the home automation system can limit then cut back the power. To determine/set/evaluate limit, can calculate or use temperature sensor(s), thermistors thermocouples (TCs), positive coefficient thermistors, negative coefficient thermistors, IC temperature measurement, semiconductor temperature measurement, etc.

The present invention works with all types of ballasts including instant start, rapid start, programmed start, dimmable ballasts, etc. Embodiments of the present invention can have internal or external power supplies/drivers.

Should the ballast at some future time fail to work properly, fail to operate, stop working, etc., the present invention allows the ballast to be disconnected, removed, etc. and, for example, a new ballast or a new power supply, power source, to be used with the present invention such that the new power source could be connected to the input of the external driver or to directly to the LED and/or OLED lights, lamps, lighting, etc. Embodiments and implementations of the external driver can have the capability to run off/be powered by AC line voltage in addition to being powered by a ballast. Embodiments and implementations of the present invention can automatically select between ballast and AC line voltage or manually, including a switch, or remote control to select whether to receive power from an AC line or a ballast (including an emergency power ballast).

In other embodiments of the present invention an input socket can be used to power the LED and/or OLED lights, lamps, lighting, etc. In other embodiments of the present invention an input and output socket can be used to power the LED and/or OLED lights, lamps, lighting, etc. such that unless power/current is applied to the input, the LED and/or OLED lights will not turn on.

The present invention can use a ballast as a power supply including but not limited to fluorescent lamp ballasts, high intensity discharge (HID) lamp ballasts, sodium lamp ballasts, etc. in which the power from the output of the ballast(s) can be used as a power source such as an AC or DC power source including where the power from multiple outputs of a single ballast or plurality of ballasts are combined. Embodiments of the present invention can use power combining with or without isolation of any type or form including but not limited to capacitors, transformers, inductors, diodes, resistors, transistors including but not limited to other components and devices and active devices including switches, transistors, triacs, thyristors, silicon controlled rectifiers (SCRs), synchronized transistors, integrated circuits (ICs), application specific integrated circuits (ASICs) of any type, any material, any material compositions including but not limited to heterojunctions, heteromaterials, etc. to provide and perform power combining of one or more ballast outputs. The power combined outputs can be single stage, two stage, multiple stage. etc. including, but not limited to, push-pull, forward converters, flyback, buck, buck-boost, boost-buck, boost, Cuk, SEPIC, half-bridge, full-bridge, voltage mode, current mode, current fed, voltage fed, etc.

In some embodiments of the present invention, the current/power of one or more lamp outputs may be combined in any number of ways including multiple ways of providing power to individual direct fluorescent lamp replacements including the example embodiment of the present invention using power combiners, power combining, etc.

Embodiments of the present invention can work with instant start, programmed start, and/or rapid start compatible. An IC or ICs can be or can include, contain, be part of, etc., a microcontroller, a microprocessor, a field programmable gate array (FPGA), an ASIC, multiple chips including being assembled and packaged together or separately that perform these functions that may also include one or more wireless and/or wired interfaces to communicate and control, monitor, dim, etc. the present devices. In some embodiments of the present invention, for example, the fluorescent lamps comprise one or more panel lights that can fit into, be interfaced with, be connected to, be retrofitted, etc. using the existing ballast, connections, fixtures, etc.

Embodiments of the present invention can be used with different fixtures and can allow additional features not currently possible including having colors such as RGB. RGBA, other color combinations, one or more colors, white plus colors, full spectrum, form factor change other than HID lamps of all types, shapes and form factors, T8, T5, T12, other fluorescent lamp shapes, etc. including changing to, for example but not limited to, approximately 2 ft.×2 ft., 3 ft.×2 ft., 3 ft.×3 ft., 2 ft.×4 ft., 3 ft.×4 ft., etc.

The present invention can also be used to provide a smart, intelligent and interactive light source to treat seasonal affective disorder (SAD) among other light/phototherapy treatments/applications/needs/etc. For example, the present invention can be used to aid in SAD treatment by tuning on appropriate brightness, color temperature, wavelength(s), intensity, light output lighting at one or more locations within a room, house, building, hospital, care facility, nursing home, anti-depressant facility or location, work environment, business, industrial setting, locations, etc. Such SAD treatment lighting can be put on the back (i.e., facing inside/interior) of solar curtains, solar drapes, solar shades, solar blinds, solar panels, etc. and coordinated, scheduled and/or sequenced with the solar energy/power uses of the present invention including harvesting energy to be used a later time to power the SAD treatment lighting, or to time shift the lighting or to perform other scheduled events including being used to simulate a sun rise wake up by gently or otherwise (e.g., quickly, immediately, ramped from zero (full dimming) to full intensity/power/lumens/etc. over a prescribed amount of time that can set or programmed by the user, automatically, by caregivers, by family or friends, by others, by the season and time, date, etc. of the year, remotely, locally, etc.). In a similar fashion, the present invention can be used to simulate sunset at any time of the day in any location in the world including locations with long periods of sun hours or short sun hours (e.g. Alaska. Nordic countries, parts of the world close to the North Pole, South Pole, etc.) depending on things such as the time of the year, weather, altitude, shadowing, obstructions, enhancement of light due to reflections including reflections off of surfaces, etc. In addition, circadian rhythms enhancements, alignments, resets, adjustment, shifts, etc. may also be accomplished and embodied in the present invention to provide appropriate levels and intensity illumination including artificial illumination from solid state lighting, fluorescent lighting and other sources of lighting to simulate and stimulate, for example, but not limited to, full spectrum lighting, partial spectrum lighting, blue wavelength/shifted lighting, red wavelength/shifted lighting. The lighting can also be coordinated, scheduled and/or sequenced with heating or cooling of the room, location, environment as well as turning on (or off) radios, televisions, cell phones, computers, tablets, personal digital assistants (PDAs), other entertainment and/or communications devices, systems, components, etc. Embodiments of the present invention can accomplish this by many methods including but not limited to receiving signals from one or more sensors and detectors including, but not limited to wired and wireless signals, feedback, information, etc. from one or more devices including time, day and date information, global positioning system (GPS) information, weather conditions, atomic clock signals and information, solar sensors and detectors, sunlight sensors and detectors, photo sensors and detectors, light sensors and detectors, electromagnetic and/or optical detectors, frequency and/or wavelength detectors and sensors, CCD imaging including visible and/or infrared imaging, sensing and detection, infrared detection and sensing, ultraviolet detection and sensing, spectrum analysis, detecting and sensing, optical and electromagnetic spectrum detection and sensing, temperature sensors and detectors, humidity sensors and detectors, barometric sensors and detectors, rain and/or snow sensors and detectors, moisture sensors and detectors, wind sensors and detectors, other location and proximity sensors and detectors, motion sensors and detectors, etc. and/or combinations of these, etc. These and other types of information, sensors and detectors may also be combined and/or connected with wearable devices and other sensors that can detect, for example, but not limited to, heart rate, blood pressure, phase of the circadian rhythm cycle, other information about circadian rhythm, ambient light, pressure, movement, electroencephalogram/electroencephalography (EEG), electrocardiography/electrocardiogram (EKG or ECG), brain waves, oxygen level, brain waves, muscle movement, body temperature, pulse rate, actimetry, sleep actigraphs, temperature, polysomnography (PSG), mood, emotional state, etc. Wearable devices can include, but are not limited to, wrist devices, or watch-shaped devices worn on the wrist of the non-dominant arm, detectors and sensors, sleep management and monitoring sensors, systems, etc. including for awake, REM, deep sleep, various other states of sleep and wake, etc., delayed sleep phase disorder, perspiration, orientation, location, vertical or horizontal sensing, etc., speech, speech patterns, voice, weather, etc. Such signals, input, feedback, information, etc. can be used to, for example, to set the level, spectrum and intensity, emulated sunlight spectrum, white temperature, color temperature, duration and intensity of treatment, etc. In addition, sensors can include light sensors, photosensors, spectrum analyzers including optical spectrum analyzers, light sensors with notch filters, motion sensors, proximity sensors, radio frequency identification (RFID), cell phones, smart phones, tablets, etc. Smart phones, tablets, laptops, computers, dedicated control and/or interface units, etc. may be used to, for example, but not limited to, transmit and/or process the information via applications or apps or can use apps to display, store, log, analyze, etc. data, results, performance, control, provide feedback etc. The present invention can incorporate and use open platforms including but not limited to Google Fit, Apple HealthKit, FitBit, etc. The present invention allows for scheduling/programming of events remotely including for persons who are unable to do so themselves which can also include remote scheduling, programming, monitoring, control, etc. The present invention can also be used to treat and/or assist in the treatment of dementia and related conditions. The present invention can also provide power for other uses, functions including but not limited to fans, motors, heaters, blowers, fan blades, security cameras, surveillance cameras, monitors, monitoring systems, web-based cameras, motorized cameras, etc., USB and other charging, auxiliary power, etc., battery backup, emergency batteries, microphones, speakers, sensors, WiFi, LiFi, wireless power, combinations of these, etc. In some embodiments of the present invention, various wireless approaches can be used that for example, but are not limited to, involve WiFi and Bluetooth to communicate with devices including but not limited to smart phones, IPods, IPads, tablets, computers, laptops, etc. along with direct communication including, but not limited to, wireless remote controls, voice control, voice recognition, etc. via Bluetooth, ISM, other wireless frequencies, etc. For example, a microphone that can communicate via Bluetooth and/or ISM or other wireless frequencies can be used to communicate with the present invention. In some embodiments of the present invention, a buck, buck-boost, boost-buck, and/or boost switching topology is used to provide power for the present invention. As an example, a buck circuit can be used to provide AC to DC regulated power to the present invention. An example of an efficient way of providing such power is to for example have the buck circuit be controlled based on the lowest and strictest required regulation voltage that typically is used for the control circuits such as, for example, the integrated circuits which could, for example, consist of but is not limited to a microcontroller, microprocessor, FPGA, DSP, CLD, etc., one or more of these or each of these, wireless or wired ICs, interfaces, devices, protocols, etc. including but not limited to, WiFi, Bluetooth, IEEE 801, ISM frequencies, other bands and frequencies, I2C, RS232, RS485, DMX, DALI, SPI, USB, serial, etc., combinations of these including one or more of the same or different ones, etc. that is used with one or more windings (as discussed in U.S. patent application Ser. No. 13/674,072, filed Jun. 2, 2013 for a “Dimmable LED Driver with Multiple Power Sources” which is incorporated herein by reference for all purposes) on the buck inductor to provide multiple outputs including, for example, but not limited to, typically 3 V to 5 V for the control electronics, 5 V to 15 V to 20 V for the power devices including the gate drive for the power transistors including FETs and in some embodiments bipolar junction transistors (BJTs) and Darlingtons and IGBTs. In addition to these windings, a winding or windings for, for example, can also be used to provide power to the LEDs and/or OLEDs as well as power for other needs and applications including fans, motors, USB, battery chargers, etc. Linear regulation, linear regulators, switching regulators, voltage regulators, current regulation, current regulators, shunt, regulation, shunt regulators, combinations of these, etc. may be used.

In some embodiments of the present invention persons and, for example, animals experiencing or suffering from seasonal affective disorder and, for example, circadian rhythm and sleep disorders, etc. can also reap additional benefits that the present invention can have for these people and, for example animals, birds, other living creatures including people who sleep patterns are shifted, for example, at such as night shift workers, who often must sleep during the day and be awake at night or people recovering from jet lag, a change in time zones, countries, locations, daylight shifts, etc. that need to regulate their circadian rhythms and sleep patterns to that different from local day and night time.

The present invention does not only apply to fluorescent lamps and fixtures and luminaires of all types and kinds—the present invention also applies in general to all types of high intensity discharge (HID) lighting including but not limited to mercury vapor lamps, metal-halide (MH) lamps, ceramic MH lamps, sodium-vapor lamps, xenon short-arc lamps, other types of arc lamps, sodium-based and other element-based lighting, gas discharge, etc.

Implementations of the present invention can also use combinations of example embodiments of the present invention—for example, a buck (or buck-boost, boost-buck, boost, fly back, forward converter, push-pull, etc.) can be combined with a the ballast current control and other example embodiments shown herein to achieve implementations that can be used with universal AC line voltage up from below 80 VAC to greater than 305 VAC and even 347 VAC and 480 VAC 50/60 Hz (and also 400 Hz) as well as magnetic ballasts and electronic ballasts, including but not limited to, instant start, rapid start, programmed start, programmable start, dimming ballasts, pre-start, etc. FIG. 1 shows an example of such a combined circuit that, in certain implementations, can also be locally or remotely controlled and dimmable. In FIG. 1, a buck circuit is used for low frequency operation (i.e., 50/60 or 400 Hz) and magnetic ballasts and the current control is used for electronic ballasts. The buck (or related switching circuit) can be used to control the current and/or voltage to the LED, OLED or QD load and by adjusting, for example, but not limited to the duty cycle of the buck or related switching circuit/topology (i.e., for example, the switching element, the output to the load could be dimmed or increased. The example embodiment shown in FIG. 1 consisting of a switching element and associated sense and measure circuitry to shunt current as needed or desired including for dimming while switching element could be either fully turned on or, depending on the implementation, fully turned off. The drain of the transistor or transistors can be attached to a point in front of a diode that can be used to block the shunting from directly affecting and shorting/shunting the output capacitor and load as discussed elsewhere in this document. Of course in some embodiments and implementations of the present invention, a buck (or buck-boost, boost-buck, boost, fly back, forward converter, push-pull, etc.) can be used for all types of magnetic and electronic ballasts as well as AC line voltage ranging from less than 80 VAC to greater than 480 VAC if desired. As discussed herein, other elements including but not limited to, EMI filters (consisting of, for example but not limited to, chokes, inductors, toroid inductors and chokes, two and four legged inductors, transformers, capacitors, diodes, resistors, other elements, etc.). OVP, OTP, SCP, OCP, shock hazard/pin safety, dimming, remote control and monitoring, color changing, color switching, etc. can be included into these and other implementations of the present invention. Embodiments of present invention are not restricted to the buck and can also be buck-boost, boost-buck, boost, fly back, forward converter, push-pull, etc. and include a shunt combination. Items such as snubbers and clamps, rectification bridges, gate networks (e.g., resistors and diodes, etc.), other components and connections, etc. have been left off as well as some of the details and connections for the control circuit labeled IC. The control circuit can use information, for example, including but not limited to about frequency and voltages to determine whether a low frequency ballast or AC line voltage or a high frequency ballast to determine the appropriate signals to apply to switches. In some embodiments and implementations of the combined buck (etc.) and shunt approach, a microcontroller or microcontrollers and/or DSP(s), FPGA(s), microprocessors, etc. can be used in place of or to, for example, augment and support the microcontroller(s), etc. A tagalong inductor (for which there could be one or more) such as those disclosed in U.S. patent application Ser. No. 13/674,072, filed Nov. 11, 2012 by Sadwick et al. for a “Dimmable LED Driver with Multiple Power Sources” can be used with embodiments of the present invention. It should be understood that one or more tagalong inductors could be incorporated into the example embodiment discussed and shown herein can contain tagalong inductors. It should be also understood that there many numerous variations of the example embodiments shown and discussed herein and nothing should not be construed or taken as limiting in any way or form.

In addition other windings may be used with the present invention to provide power including, but not limited to, bias and auxiliary power, current, voltage, etc. including isolated power, current, voltage, etc. as needed. These other power supplies may be isolated and may be of any type including, but not limited to, forward, flyback, resonant, current-mode, voltage-mode, current-fed, voltage-fed, etc.

Hazard/leakage/shock protection can be implemented as discussed, illustrated, shown, depicted, discussed, etc. herein including before (for example, using a bidirectional switch to stop/block/etc. the current/voltage from the ballast), after the rectification stage, transformer, etc.

The example heater/cathode emulation circuits shown in FIGS. 1 through 4 in which capacitors and resistors form an example pair of heater emulation circuits. In addition, circuit functions and features illustrated, depicted, discussed, etc. herein that use analog and/or digital circuits may be implemented using microcontrollers, microprocessors, digital signal processors (DSPs), field programmable gate arrays (FPGAs), etc.

Hazard/leakage/shock protection can also be accomplished by inserting a bidirectional switch (i.e., in either or both legs of the primary of the transformer. For example, an example embodiment of the present invention would include inserting the primary of a transformer in between capacitors and use the gates of the bidirectional switches which can be powered from a floating power supply with, for example, a similar detect/monitor and control approach as described herein and depicted, for example, in the Figures.

The use of capacitors, a switch with capacitors, capacitors and diode bridge or other method of rectification including synchronous transistors, bidirectional switch(es) without the need for a rectifier, including versions that use digital and/or analog and/or microcontrollers, microprocessors, DSPs, FPGAs, etc. can be used to short out the ballast. Capacitors can also be used to limit the maximum current from the ballast and provide protection including, but not limited to protection from damage to the ballast due to voltage and/or current levels from or across the 50 or 60 Hz AC lines. In some embodiments of the present invention only one capacitor is included which could consist of a single capacitor or multiple capacitors that could for example be put in series, in parallel, in combinations of series and parallel, etc. In other embodiments of the present invention two or more capacitors are used. In some embodiments of the present invention, use of capacitors or corresponding capacitors in other Figs. or any subset or combinations of these may result or assist/aid in increased efficiency. The impedance of these capacitors, for example, can be used to increase the effective AC resistance at the ballast frequency to reduce the voltage (and current) burden while also limiting or assisting in limiting the short circuit current through the ballast in the case of a shorting or shunting event or abnormality.

In addition, other protection circuits, functions and features can be added/incorporated into the present invention. For example, embodiments of the present invention can also contain an over-temperature protection function—such a function is performed by, for example, but not limited to, a thermistor in parallel with Zener diode with both in series with resistor or the use of a bipolar transistor where the emitter base voltage decreases with increasing temperature. Again, in general, embodiments of the present invention can use AND, OR. NAND, NOR, and/or other types of Boolean Algebra operations and operations to accomplish various types of functions including but not limited to the optional hiccup mode.

Embodiments of the present invention may use and/or incorporate microcontrollers, FPGAs, microprocessors, DSPs, CLDs, etc. to perform some or all of the functions and capabilities of the present invention including but not limited to detecting and asserting control signals identifying: over voltage, over temperature, shock hazard/pin safety, current control (i.e., constant current, overcurrent, etc.), under voltage protection, transient protection, etc. by using signals either directly or derived, filtered, modified, scaled, etc. from voltage(s), current(s), temperature(s), etc. associated, for example, with the ballast and the present invention. A switch or switches may be directly or indirectly (i.e., isolated, through other circuits, scaled, etc.) connected to the microcontroller, etc. or may be directly connected to the microcontroller, etc. with or without additional components and used to detect the state of the switch (i.e., open or closed including fixed, CW, momentary, 1, 2 or more pole, 1, 2 or more throw, etc.) in terms of enabling or disabling or taking other action(s) when it comes to shock hazard. The microcontroller. etc. can work in conjunction with other components, circuits, switches, devices. etc. including but not limited to those discussed herein. In addition, the frequency of the ballast or AC line can be detected, measured, sampled, sensed, analyzed, recorded, stored, etc. for a number of purposes and uses including but not limited to determining whether an electronic ballast is connected to the present invention and making and taking appropriate decisions and actions based on the frequency information/signal. Note: the switch or switches used for shock hazard/pin safety protection of embodiments of the present invention can include any suitable semiconductor transistor, including but not limited to bipolar, MOSFET, IGBT, JFET, etc., relay(s) including but not limited to coil, contact, mechanical, electromechanical, Reed, mercury, mercury-wetted, vacuum, solid state, semiconductor, etc. in single, parallel, series, stacked, etc., combinations of these, etc. A remote control signal can be used to signal to the microcontroller that the fluorescent lamp replacement has been correctly installed and that pins are enclosed in the fixture. The microcontroller can then disable the shock hazard/pin safety system to enable current to flow through the pins to power the load. In some embodiments, the remote control signal is bi-directional, allowing the microcontroller to transmit status information to a remote device such as a computer, tablet, phone, etc. about the fluorescent lamp replacement. Again, in addition, the frequency of the ballast or AC line can be detected, measured, sampled, sensed, analyzed, recorded, stored, etc. for a number of purposes and uses including but not limited to determining whether an electronic ballast is connected to the present invention and making and taking appropriate decisions and actions based on the frequency information/signal.

A fluorescent or HID lamp replacement circuit can be used with and have shock hazard/pin safety protection. An emulation circuit can be included to emulate various characteristics of an instant start, rapid start, prestart phases of operation in a replaced fluorescent lamp in order that the corresponding ballast operate correctly with the fluorescent lamp replacement. An EMI filter 3406 can be included to manage electromagnetic interference. A power supply such as, but not limited to, a buck converter or, for example, a buck-boost, boost-buck, boost, fly back, forward converter of any type and kind, push-pull, etc. can be included to power a solid-state lighting load from the ballast output.

The buck converter can also be a boost-buck, buck-boost, boost, etc. converter. The solid-state lighting load may comprise LEDs, OLEDs, QDs, combinations of these, etc. A circuit as disclosed elsewhere herein that contains at least one diode, at least one inductor, and/or at least one switching element/switch can also be included to provide AC line and ballast current control operation and also to manage shock hazard/pin safety. The buck converter can have OVP, OTP, OCP, shock hazard/pin safety protection, constant current, etc. Normally on (NO) and normally closed (NC) mechanical switches that are, for example single or double (or higher) and single (or higher) pole can be used to indicate when external pins on the fluorescent lamp replacement are exposed.

The present invention including but not limited to the figures depicted herein can be used with AC line voltage including but not limited to 80 to 305 VAC 50/60 Hz, 347 VAC 50/60 Hz, other 50/60 Hz voltages, magnetic and electronic ballasts, low frequency and high frequency ballasts, instant start, rapid start, programmed start, program start, pre-start, warm, cold, hot types of ballasts, etc.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc.

The various implementations and embodiments of the present invention including the buck converter or other power supply can be controlled by a dimming signal as described herein. A dimming controller can also receive status information.

The control circuit can use reference voltages and/or currents from any suitable sources, and time constants can be applied as desired, for example with resistor and capacitor, and feedback from transformer or inductor with a tagalong winding through, for example, a diode and resistor.

When an over-voltage, over-current, over-temperature or other condition is detected, the control circuit can short out the current from the ballast output, preventing current from reaching the load. A diode can be used to prevent certain capacitors from being discharged by the short. A wireless or wired signal can be sent and via reference set point which for example but is not limited to, could be a voltage, the output current to the LED, OLED and/or QD could be reduced or increased as desired. In general, the load current can be higher than the current supplied by the ballast using buck, buck-boost, boost, boost-buck, fly back, forward converters. Cuk, push pull, SEPIC, etc. Also, in general, a voltage can be used to set the dimming level by, for example, decreasing or increasing the voltage with, for example, but not limited to, the voltage being used as a reference and/or set point.

The control circuit can have an optional power supply source that takes power from a rectified power supply at node 3920 that is optionally further regulated using a regulator consisting of resistors, Zener diodes, capacitors and one or more transistors. All types of voltage references can be used to achieve a stable voltage reference including, but not limited to, bandgap references, precision voltage references, etc. Resistors can form a voltage divider that acts as a reference set point which could also be filtered by, for example, a capacitor that, for example, is fed to the non-inverting terminal of a comparator 3946 (or similar function such as an op amp). The voltage from a sense resistor can be fed to the inverting input of the comparator via an optional filter/time constant consisting of, for example, a resistor and capacitor such that when the signal from the sense resistor is larger than the reference set point signal, the comparator goes low and provides a negative pulse.

The negative pulse from comparator can be fed to an inverter made up of MOSFET and resistor. A time constant can be included to control the rise and/or fall time at the gate of the MOSFET, for example with a resistor and a capacitor and can act, behave and perform as a one shot. The inverter output is fed to, for example but not limited to, the gate of a MOSFET, BJT, or a Darlington pair either integrated or made up of discrete bipolar junction transistors which acts as a shunting transistor. The collector of the Darlington pair can be connected, for example, to shunt the current of the rectified ballast output through the Darlington pair. In other embodiments of the present invention, other types of transistors, including but not limited to, MOSFETs, IGBTs, GaNFETs, SiCFETs, BJTs, etc. can be used in place of the Darlington transistor. Again, this shorts out the ballast and prevents current from reaching the load or output capacitor, while a diode prevents the output capacitor from being discharged and turning off the load. In the event that the current sensed is too high, then the output of the comparator (or op amp) goes low which results in turning on the Darlington pair (or other types of transistor(s)) to shunt the ballast output current. Other embodiments of the present invention may use different implementations, circuits, etc. that perform the same/similar function/operation, etc. Again, in general, embodiments of the present invention can use any type or form of circuit, implementation, design, etc.

Another example embodiment of an over-voltage protection (OVP) and over-temperature protection (OTP) circuit can be provided by voltage divider resistors, a bipolar junction transistor, and other resistors; in some embodiments a thermistor can be used with or in place of voltage divider resistors, bipolar junction transistor (BJT), etc. wherein the decrease in the BJT emitter-base voltage of approximately—2 mV/C is used to reduce the voltage at the inverting pin of a comparator. Voltage divider resistors and a transistor connect other resistor(s) in parallel with an optional thermistor when the supply voltage (e.g., 15V) based on the ballast output is at the desired level, creating an over-temperature reference voltage across resistor and an optional thermistor that is temperature dependent. A reference voltage for the over-voltage protection is provided in parallel using, for example, a resistor or resistors and a Zener diode that act as a reference set point which could also be filtered by, for example, capacitor. The reference voltage for the over-voltage protection, modified by the over-temperature circuit, is fed to the non-inverting terminal of a comparator (or similar function such as an op amp).

The over-voltage and over-temperature reference set point is compared in a comparator with, for example, a voltage, scaled in voltage divider which is the voltage used to drive the LED or OLED or QD load. The scaled voltage is fed to the non-inverting input of a comparator/op amp. Gain/hysteresis setting resistors can be used with the comparator. When the thermistor gets hot, its resistance decreases, lowering the over-voltage and over-temperature reference set point, which would turn on the comparator and allow current to flow to shutdown signal. When BJT gets hot, the base to emitter voltage drops and the collector conducts more current eventually turning on BJT stronger as the temperature increases and reducing the voltage at the inverting input of comparator.

When the scaled voltage is higher than the reference set point signal either because of an over-voltage condition or because of an over-temperature condition lowering the reference set point signal, the comparator goes high, powering the shutdown signal. The shutdown signal can also be used to drive an optocoupler to, for example, short the drain to source of a transistor, etc.

In some embodiments, over-voltage protection is provided by a Zener diode and a resistor, a transistor and another resistor. If the voltage rises too high, the Zener diode breaks down and turns on transistor, turning on transistor, which turns off the shutdown signal and any optocoupler driven by the shutdown signal.

The present invention supports all forms and types of dimming of the FLR including by wired and wireless methods for example, but not limited to, controlling the set point/reference for the current or voltage of the FLR. Radio frequency identification (RFID) and similar such systems can be used with the present invention to turn on or off or dim embodiments and implementations of the present invention remotely, voice commands and voice recognition, sound, motion, gesturing, speaking, etc.

The present invention provides protection against damage and injury to the driver and LED array and damage and injury to the user, installer, other personnel and humans in general

The switches including the transistor switches may consist of transistors in series or in parallel or both to electrically inhibit/disrupt/break the path/etc. of the ballast current.

In some embodiments of the present invention, one or more mechanical switches which could be in forms including, but not limited to, a push-button or momentary switch(es) that, for example, when depressed makes contact and completes the circuit may be used with the present invention. The switch can either hold off/disrupt/block/etc. the output voltage of the ballast or be used in conjunction with one or more electronic devices to hold off/block/disrupt the path of electrical conduction from the ballast output to, for example, to the FLR including to ground in the case of a fault or hazard condition or situation. Embodiments of the present invention can use low voltage switches including, but not limited to, mechanical low voltage switches that typically have no more than 15 to 20 volts potential/voltage difference across the switch contacts to complete, for example, the gate drive to FET or IGBT, etc., including, but not limited to, MOSFETs, JFETs, depletion mode FETs, enhancement mode FETs, MESFETs, HEMTs, MODFETs, GaNFETs, SiCFETs, etc.

With many common electronic ballasts, including instant start, rapid start, programmed start, programmable start, pre-start, dimmable including wall, triac, wired, wireless, powerline control ballasts, etc., the current typically may be greater than 100 mA and equal to or less than 200 mA with a value typically in the range of 130 mA to 160 mA or slightly less or slightly greater than these values results in uniform performance for most ballasts except for ballasts designed with, for example, a low ballast factor specifically designed to require and supply lower output power to a fluorescent tube thereby requiring less power and saving energy. In some embodiments which, for example, do not directly shunt the current, the LED or OLED or QD current can be higher, for example in the range of 200 mA to 400 mA or higher for example with inductor (and/or inductor with one or more tag-along winding(s) or transformers, etc.), diode, capacitor circuits such as, but not limited to, buck, buck-boost, boost-buck, boost, fly back forward converters, push pull, etc.

Warning of a danger/hazard condition to exist may include a warming light or sound or other means of warming/alerting of such a potential condition/situation. Such a warning may be optional.

Heater emulators could include incandescent light bulbs, lamps, MEMS resistors, bridges, heaters, filaments, thermostructures, thermocouples, capacitors, resistors, other passive components, inductors, any types of combinations of these, etc.

Dimming can be accomplished for any type of control including pulsing including but not limited to duty cycle variation, frequency variation. PWM, burp, hiccup, voltage controlled/referenced, etc. in either a shunt or series or combination by, for example, changing the set point that controls, limits, sets, etc. the current or voltage for the fluorescent tube replacement to the LEDs or OLEDs or QDs. Such control could be, for example, a smaller or larger voltage. Such emulation circuits could also consist of, for example, capacitors and resistors, for example, for both rapid and instant-start, programmed start, programmable start, dimmable, pre-start and other types of ballasts. Such circuits could have symmetrical or asymmetrical components and component values. Low pass and or high pass circuit can also be used including for frequency detection/sensing, measuring, etc.

The series switch for hazard/leakage current protection can also be used to turn off the ballast mode of an universal and ballast mode FLR that can accept, for example, both AC line and electronic ballast output to power the light source/load such as LEDs and OLEDs and quantum dot (QD)-based light sources.

In some of the particular embodiments, a FET is utilized, however the present invention is not limited to the use of a FET or FETs and other types of switches such as, but not limited to, bipolar junction transistors (BJTs) including all types of BJTs such as npn and pnp, npn Darlingtons and pnp Darlingtons, n-channel or p-channel junction FETs (JFETs), insulated gate bipolar transistors (IGBTs), all types of MOSFETs including p-channel and n-channel MOSFETs, NFETs, unijunction transistors, etc. made from any type of materials including semiconductors such as silicon, silicon carbide, gallium arsenide, gallium nitride, silicon germanium, indium phosphide, gallium aluminum arsenide, gallium aluminum nitride, etc.

Note, additional diodes or bridges as illustrated and depicted in the figures may be used in any of the embodiments depicted in the remaining figures and previous figures.

For example a simple example embodiment of the present invention could include a high frequency diode bridge (or bridges) and a shunt regulator along with protection switch(es) and circuitry. Dithering of, for example, but not limited to, frequency, duty cycle, width, etc. may be used with the example embodiments shown herein and in general for the present invention to, for, example, but not limited to, to provide EMI dithering and reduction.

Another example embodiment of a fluorescent lamp LED replacement with a high frequency diode bridge (or bridges), a shunt regulator and current feedback along with protection switch(es) and circuitry.

An example embodiment of the present invention includes a fluorescent lamp LED (or OLED or QD) replacement with a high frequency diode bridge (or bridges), a shunt regulator and current feedback and additional over-protection and current control feedback.

The present invention can also be used with example embodiments of a fluorescent lamp LED replacement that can operate and receive power either from a ballast or from the AC line voltage with a high frequency diode bridge (or bridges) and a current to voltage converter that can be switched to operate a LED driver should a ballast be used with the present invention or used with AC input voltage applied to the fluorescent fixture terminals.

The present invention can also be used with example embodiments of a fluorescent lamp LED replacement with a high frequency diode bridge (or bridges) and a current to current transformer (or transformation) with a shunt regulator and associated feedback and control to set the current of a LED or OLED, or QD or combinations of these output load.

The present invention can also be used with example embodiment of a fluorescent lamp LED replacement with a high frequency diode bridge (or bridges) and a current to current transformer (or transformation) that feeds a rectification stage with a shunt regulator and associated feedback and control to set the current of a LED or OLED, or QD or combinations of these output load where the feedback and control information is fed back to the shunt regulator.

The present invention can also be used with an example embodiment of a fluorescent lamp LED replacement with a high frequency diode bridge (or bridges) and a current to current transformer (or transformation) with a shunt regulator and associated feedback and control to set the current of a LED or OLED, or QD or combinations of these output load where the feedback and control information is also fed back to the current to current transformation stage and the rectification stage.

The present invention can also be used with an example embodiment of a fluorescent lamp LED replacement with a high frequency diode bridge (or bridges) and a current to current transformer (or transformation) with a shunt regulator and associated feedback and control to set the current of a LED output load where the feedback and control information is also fed back to the current to current transformation stage and the shunt regulator.

The present invention can also be used with an example embodiment of a fluorescent lamp LED replacement with a high frequency diode bridge (or bridges) and a current to current transformer (or transformation) having protection and detection with a shunt regulator and associated feedback and control to set the current of a LED output load where the feedback and control information is also fed back to the current to current transformation stage and the shunt regulator.

The present invention can also be used with an example embodiment of a fluorescent lamp LED replacement with a high frequency diode bridge (or bridges) and a current to current transformer (or transformation) having protection and detection with a shunt regulator and associated feedback and control to set the current of a LED output load where the feedback and control information is also fed back to the current to current transformation stage and the shunt regulator as well as from the protection and detection stage.

Feedback, protection response, etc. can come from and go to one or more of the stages. Features, functions, circuits, operations, etc. discussed and shown herein can also be performed using microcontrollers, microprocessors, DSPs, FPGAs, etc.

The present invention can also be used with an example embodiment of a ballast driver for a fluorescent lamp LED replacement. High frequency diodes form a high frequency full wave rectification bridge. Additional diodes or bridges may be included as needed or desired. The shunt transistor acts as a shunt switch to shunt current from the ballast as needed or required for a particular application and also serves as a protection against over-current including over-current transients. An additional diode prevents the shorting of the load (LEDs) when the transistor is turned on and shorts (shunts) the ballast.

The present invention can also be used with an example embodiment of a ballast driver for a fluorescent lamp LED replacement. High frequency diodes form a high frequency full wave rectification bridge. Additional diodes or bridges may be included as needed or desired. A transistor or transistors acts as a shunt switch to shunt current from the ballast as needed or required for a particular application and also serves as a protection against over-current including over-current transients. An additional diode prevents the shorting of the load (LEDs and/or OLEDs and/or QDs) when the transistor is turned on and shorts (shunts) the ballast. Optional capacitance may be added and may consist of one or more capacitors. An optional resistor acts as a current sense and could be replaced with any other type of current sense element including but not limited to current sense transformers, current transformers, sense transistors, etc.

Optional capacitance may be added and may consist of one or more capacitors as well as adding an optional inductor and/or an optional sense element which could be a resistor that acts as a current sense or could be any type of current sense element including but not limited to current sense transformers, current transformers, sense transistors, etc.

The present invention can also be used with an example embodiment of a ballast driver for a fluorescent lamp LED replacement. High frequency diodes form a high frequency full wave rectification bridge. Additional diodes or bridges may be included as needed or desired. Capacitors attached to the input of the high frequency bridge act as a current limiter and also present high impedance elements at low frequencies including, for example, at or around 50 or 60 Hz and limit the current that can be passed to the high frequency bridge and the rest of the circuit/driver of the FLR so as to protect the circuit from high voltage AC inputs. A shunt switch can be used to shunt current from the ballast as needed or required for a particular application and also serves as a protection against over-current including over-current transients. A diode prevents the shorting of the load (LEDs) when the switch is turned on and shorts (shunts) the ballast by, for example, a Controller, which for the present invention can be used to both regulate and control the protection. Optional capacitance may be added and may consist of one or more capacitors. One or more optional sense elements which could be resistors act as current sense(s) and could also be any type of current sense element including but not limited to current sense transformers, current transformers, sense transistors, etc. Any type of switch, transistor, vacuum tube, semiconductor device, etc. may be used. A resistor and Zener diode may provide a voltage limit protection. Additional elements including but not limited to additional diodes may be added/incorporated/etc. and may also include/incorporate any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to detect frequency including low-pass, high-pass, band-pass, notch filters of any order. Audio detectors, frequency to voltage converters, tone detectors, any form and type of frequency detection, etc. and combinations of these may be used. In other embodiments, circuits that can be either powered or not powered, as the case may be, can be used to enable either ballast circuits or AC line circuits. In addition, voltage and/or current detect circuits may be used in place of or to augment the frequency detect circuit. The frequency detect circuit can detect and discriminate low frequency (i.e., 47 to 63 Hz, 400 Hz) AC input line frequencies from, for example, kHz (i.e., typically above 32 kHz and often above 40 kHz electronic ballast output frequencies).

The present invention can also be used with an example embodiment of a ballast and universal AC input driver for a fluorescent lamp LED replacement. Additional diodes or bridges may be included as needed or desired. Inductors along with capacitors can be used as an EMI filter which could also include chokes, resistors, other capacitors, inductors, etc. and other arrangements, implementations, etc. Other EMI filters could be used as needed on other parts of the input or output. An inductor, transistor and a diode can form, for example, a buck or buck-boost converter. Although a buck-boost is mentioned, any type of converter, including, but not limited to, buck, boost, boost-buck, Cuk. SEPIC, flyback, forward-converter, fly-back converter, etc. may be used. High frequency diodes or synchronous transistors can be used to form a high frequency full wave rectification bridge. Capacitors at the input of the high frequency full wave rectification bridge provide both current limiting to the FLR and also act as high impedance elements at low frequencies including, for example, at or around 50 or 60 Hz and limit the current that can be passed to the high frequency bridge and the rest of the circuit/driver even for AC input voltages typically up to 480 VAC and higher if necessary. A transistor can act as a shunt switch to shunt current from the ballast as needed or required for a particular application and also serves as a protection against over-current including over-current transients. A diode prevents the shorting of the load (LEDs or OLEDs or QDs or combinations of these) when either the shunt control transistor or a second over voltage protection shunt transistor is turned on and shorts (shunts) the ballast. Optional capacitance may be added and may consist of one or more capacitors along with optional resistors in parallel or series or both and, in some embodiments, inductors. Optional sense elements which could be resistors that act as a current sensor or could also be any type of current sense element including but not limited to current sense transformers, current transformers, sense transistors, etc. may also be added. Capacitors and diodes and other elements may be used to form a circuit such that an appreciable and useful voltage is developed, for example, across a resistor and capacitor in parallel with an optional protection device or devices such as a Zener diode to drive and turn on a transistor when the input can provide a high enough drive (i.e., kHz) and has little voltage insufficient to drive and turn on a transistor for frequencies, for example, in the range of 47 to 63 Hz or, also for example, 400 Hz. Although a MOSFET is typically used for the transistor, any type of switch, transistor, vacuum tube, semiconductor device, etc. may be used. Again a Zener diode along with other components can provide, for example, voltage limit protection and also in certain embodiments current limiting. Other transistors may be used in the ballast mode to, for example, provide the return path for the ballast mode if needed. Additional elements including but not limited to additional diodes or other elements including but not limited to resistors, capacitors and/or inductors may be added/incorporated/etc. into the circuitry. The circuit may be any type of circuit, and may contain, for example, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to detect frequency including low-pass, high-pass, band-pass, notch filters of any order. In addition, voltage and/or current detect circuits may be used in place of or to augment the frequency detect circuit. The frequency detect circuit can detect and discriminate low frequency (i.e., 47 to 63 Hz, 400 Hz) AC input line frequencies from, for example, kHz (i.e., typically above the audio frequencies and usually above 32 kHz and often above 40 kHz electronic ballast output frequencies).

While illustrative embodiments have been described in detail herein it is to be understood that the concepts disclosed herein may be otherwise variously embodied and employed. In addition, the present invention is applicable to both non-isolated and isolated circuits, including, buck, boost, buck-boost, boost-buck, cuk, fly-back, forward transformers, etc. in, for example, but not limited to, continuous conduction critical conduction, discontinuous conduction, etc. including resonant approaches, topologies and designs. The present invention can be used in replacement lamps including linear replacement lamps that are designed to provide cool white, bright white, warm white, soft white, etc. (i.e., color ranges that typically span from less than 2700 Kelvin to greater than 6500 Kelvin color temperature with appropriate color rendering index (CRI) and other such optical desired optical performance and perception, etc. The present invention may also be used with multi-color LEDs and organic LEDs (OLEDs) including but not limited to red-green-blue (RGB) LEDs with or without white LEDs, etc. Nothing in this document should be viewed as limiting in any way or form the present invention as applied to protection for LED replacement lamps for fluorescent lamps. For example, some embodiments of the present invention may use color changing, color tunable, color changing with or without white light, color rendering, etc. lighting including red blue green (RGB) with or without white LEDs, OLEDs, QDs or other light sources that can be controlled, tuned, monitored, adjusted, changed, set, etc. using, for example, but not limited to, wireless, wired, powerline control, etc. where the wireless can be, but is not limited to radio frequency (RF) such as WiFi, ZigBee, IEEE 801, ISM bands, and any frequency and/or standard from less than 1 MHz to greater than 1 THz; etc. In addition analytics including input and output power, current, voltage, power factor, color settings, color rendering, temperature, color temperature, color adjustment, humidity, signal strength, etc. The present invention can also be used in conjunction with dimmers of all types and forms including but not limited to solar dimmers as described in U.S. patent application Ser. No. 13/795,149 for a “Solar Powered Portable Control Panel”, filed Mar. 12, 2013, which is incorporated herein by reference for all purposes.

The present invention may also be powered directly from, for example, 100 to 300 VAC 50 Hz or 60 Hz AC line input using any two input wires and, in general, powered from 100 to 277 VAC or higher voltage with a magnetic ballast using, for example, in some embodiments all 4 wires.

With embodiments of the present invention, the starter will automatically be left unpowered using the present invention by the additional two wires thus the removal of the starter is now unnecessary and optional. Should there be a power factor (PF) capacitor (if applicable) it is now rendered unnecessary with the present invention which can have a very high power factor and the capacitor may, under certain circumstances, actually lower power factor. However the phase and power factor of the present invention can be adjusted as needed. Removal of the capacitor would typically be recommended, but is optional. Any fixture with a magnetic ballast may be left completely unmodified so that either a fluorescent or the present invention may be used interchangeably in such a fixture with a magnetic ballast. In other embodiments of the present invention, where the embodiment(s) is/are only designed for electronic ballasts, the present invention can protect against inadvertent ‘plugging in’ to AC lines or magnetic ballasts in a number of ways and methods including the use of current limiting devices and components such as capacitors which can also serve as current/voltage limiting elements to protect electronic only FLRs. In dimming applications, the protection detection/monitoring/control/etc. can interact and know about the dimming requests, level and/or other parameters and adjust and respond accordingly. In one embodiment of the present invention, dimming can only be effected and accomplished after the FRL is safely put into operation so as to offer full protection during the installation process against injuries, harm and fatalities to the installing person or personnel. Such a feature can be made to be automatic each time the lamp is disconnected/reconnected/installed/etc.

The present invention supports power factor correction (PFC) especially for the universal AC input mode. The present invention in various embodiments supports all types of dimming including, but not limited, Triac, other types of forward and reverse phase dimming, 0 to 10 V dimming, other remote control, dimming and monitoring including powerline, wired and wireless control, etc. and also allows and supports analytics including data logging of any and all input and output parameters and values including but not limited to power factor, input and output voltage and current, efficiency, VAR, input and output power, input and output real power, etc.

In some embodiments the same controller can be used for both the series (input voltage controlled mode—IVCM) and shunt (input current controlled mode—ICCM) with, for example, an inversion of the IVCM PWM output for the ICCM. ICCM can be used for constant current control (CCC) implementations and applications.

The present invention can be used with all types of ballasts including instant-on, preheat, rapid start, programmed start, etc. Implementations can be with or without heater connections, can use multiple diodes, heater emulation circuits including both passive and active heater emulation circuits that can be analog, digital, or combinations of the analog and digital. Such heater circuits can contain resistors, capacitors, inductors, transformers, transistors, switches, diodes, silicon controlled rectifiers (SCR), triacs, other types of semiconductors and ICs including but not limited to op amps, comparators, timers, counters, microcontroller(s), microprocessors, DSPs, FPGAs, ASICs, CLDs, AND, NOR, Inverters and other types of Boolean logic digital components, combinations of the above, etc.

EMI filters can be included as needed to comply with regulatory and safety agencies. For example, an EMI filter may be required for AC line operation mode or for the ballast operation mode. Such filters can be switched in or out as needed as part of the present invention and can include one or more of the following capacitor, resistors, diodes, inductors, coupled inductors, transformers, etc. In some embodiments of the present invention, a current shunt can be used to convert the current (I) effectively to a voltage (V). In addition the circuits to perform this conversion can work with typical voltage mode circuits and should also work without issue with a DC input. As discussed above, the I-V circuit can be in some embodiments replaced/bypassed or connected through with the EMI filter for standard AC input operation. This switchover and detection can be accomplished by, for example but not limited to, manual switching, automatic switching, detection and switching, analog or digital switching, remote control, remote sensing and control, remote monitoring and control, by frequency detection/selection, current detection/selection, voltage/detection selection, waveform detection/selection, waveform shape, etc. detection/selection, a combination of the above, etc. In some embodiments of the present invention, the manual or autodetect/select can use conventional, mechanical, solid-state, hybrid relays, SCRs, triacs, transistors including MOSFETs and/or BJTs and other switchable elements. In yet other embodiments, switches, jumpers, cables, matrices, reconfigurable switches and related elements, etc. can be employed. Embodiments of the present invention may include a current limit or limits both for the ballast mode and the AC line mode.

In some embodiments and applications, there may be a need to have a feedback connection from certain parts of the circuit to the I-V section. For example, if the voltage of the I-V output is set too high it may needlessly circulate current, which would lower the efficiency. This can be addressed with proper detection and feedback to ensure high efficiency.

Some embodiments of the present invention essentially act and/or perform as a current to current converter in which the constant current from the ballast is fed to the current converter which then converts the current to desired output with the ballast voltage complying with the current and power requirement so long as it does not exceed the operational maximum voltage/power/performance of the ballast.

In general, the ballast should supply a decent to high quality+/−AC sine wave and, for many electronic ballasts, if the sine wave current is interrupted/stopped, the ballast, especially for electronic ballasts that are considered ‘smart’ and should be able to detect and capable of detecting faults, will try to respond by taking an appropriate action such as, for example, trying to restart the ballast lamp load or shutting down. The present invention is able to faithfully emulate a fluorescent lamp and provide the necessary performance and behavior for the electronic ballast to operate correctly.

The current [input] constant current [output] (CCC) shunt design (i.e., ballast mode) of the present invention works with both ˜20 to greater than 100 kHz (typical 40 kHz to 80 kHz) and 50/60/400 Hz constant current input. Embodiments of the present invention can be both low parts count and high efficiency. Some embodiments may include a sine or square-wave conversion stage. The shunt regulator is quite efficient also. In many embodiments of the present invention, at full LED current, little current goes to the shunt, so then the efficiency is very high. With the voltage [input] constant current [output] (i.e., universal AC input mode), the efficiency can also be very high as well as having a very high to ultra high power factor correction/power factor.

For universal CCC/VCC embodiments, the input terminals can be the same. As illustrated in some of the figures, for some of the embodiments only two blocks are added: a high-frequency bridge rectifier and a Zener including a lossless Zener (shunt regulator).

In some embodiments of the present invention, when in Line (V) mode the shunt is set to control point could be set to, for example, ˜400 V or ˜450 V. When in Ballast (I) mode the shunt is set to a lower voltage, corresponding to the designed power of the LED. For example, if the AC line is under ˜400 V (or ˜450 V) peak, the shunt stays off, so no power or otherwise from the shunt is drawn. This example scheme can also be used with (or without) the frequency detection mode.

In the event that, for example the manual switching was left in the incorrect configuration, the shunt would use some power and possibly produce some EMI, however the driver would still work and function.

In Ballast (I) mode the shunt could be set to, for example, ˜100V. This would draw less idle power from the ballast, and when the LED was at full power the shunt would typically barely be running/on. If the switch was left in the wrong position, the shunt would regulate at 400V, resulting in potentially more power loss (which could be addressed and eliminated with appropriate detection and correction), however the driver would still work and operate properly.

With the present invention, the feedback from the output demand would, in effect, increase the effective resistance/impedance of the converter, thus if the current source went up, the voltage draw would go down thus acting like a negative resistance.

With a ballast, the present some implementations of the present invention utilize current output control with a shunt regulator with switching mode regulation chosen to keep it efficient. In this case, the regulator switches to effective/local ground (low voltage drop equals low power dissipation) or open (no current equals low power dissipation). In addition to the passive and active components mentioned previously, other protection and detection devices and components can be used with the present invention including but not limited to tranzorbs, transient voltage suppressors (TVSs), Varistors, metal oxide varistors (MOVs), surge absorbers, surge arrestors, and other transients detection and protection devices, thermistors or other thermal devices, fuses, resettable fuses, circuit breakers, solid-state circuit breakers and relays, other types of relays including mechanical relays and circuit breakers, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

Programmable soft start including being able to also have a soft short at turn-on which then allows the input voltage to rise to its running and operational level can also be included in various implementations and embodiments of the present invention.

Some embodiments of the present invention utilize high frequency diodes including high frequency diode bridges and/or synchronous transistor rectifier bridges and current to voltage conversion to transform the ballast output into a suitable form so as to be able to work with existing AC line input PFC-LED circuits and drivers. Some other embodiments of the present invention utilize high-frequency diodes and/or synchronous transistor rectifier bridges to transform the AC output of the electronic ballast (or the low frequency AC output of a magnetic ballast into a direct current (DC) format that can be used directly or with further current or voltage regulation to power and driver LEDs for a fluorescent lamp replacement. In some embodiments of the present invention, snubber and/or clamp circuits may be used with the rectification stages (which, for example, could be diodes or transistors operating in a synchronous mode); such snubbers could typically include capacitors, resistors and/or diodes or be of a lossless type of snubber where the energy is recycled or be made of capacitors only or resistors only, etc. Such snubbers can be of benefit in reducing radiated emissions. Some embodiments of the present invention can use lossless snubbers. Embodiments of the present invention can be used to convert the low frequency (i.e., typically 50 or 60 Hz) AC line and/or magnetic ballast AC as well as electronic higher frequency AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, linear regulation, buck, buck-boost, boost buck, boost, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, NPN and/or PNP BJTs including Darlington transistors, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figure and embodiments shown are merely intended to provide some illustrations of the present inventions and not limiting in any way or form for the present inventions.

Using digital and/or analog designs and/or microcontrollers and/or microprocessors any and all practical combinations of control, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of the comparator. In addition wireless control including dimming may be used to, for example, set the reference current setpoint used, for example, to control the current supplied to the LEDs or OLEDs or QDs, etc.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming by, for example, using a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or killowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V. 0 to 3 V, etc.), digital (RS232, RS485, USB, DMX, SPI, SPC, UART, other serial interfaces, etc.), a combination of analog and digital, analog-to-digital converters and interfaces, digital-to-analog converters and interfaces, wired, wireless (i.e., RF. WiFi. ZigBee, Zwave, ISM bands, 2.4 GHz, etc.), powerline (PLC) including X-10, Insteon, HomePlug, etc.), etc.

The present invention is highly configurable and words such as current, set, specified. etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory including but not limited to EPROM, EEPROM. FLASH, ferroelectric random access memory (FRAM), a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, touch sensor(s), wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, linear regulators, etc. The present invention works with both isolated and non-isolated designs including, but not limited to, buck, boost-buck, buck-boost, boost, cuk, SEPIC, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention may also be adapted to provide overvoltage or overcurrent protection, short circuit protection for, for example, a dimming LED or OLED or QD driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design, topology, implementation, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that may contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

Embodiments and implementations of the present invention can use, interact and work with motion and light/photodetection control, and may also use other types of stimuli, input, detection, feedback, response, etc. including but not limited to sound, voice, voice control, motion, gesturing, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors), a voice sensor and/or detector, voice recognition, and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both including, but not limited to, Darlington transistors, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A lighting system comprising:
a solid state replacement lamp configured to replace a non-solid state lamp in a lamp fixture;
a power supply configured to convert power drawn from the lamp fixture to power at least one solid state light; and
a power output for an external electronic device connected to the solid state replacement lamp.
